(19) United States
(12) Patent Application Publication
(10) Pub. No.: US 2023/0422127 A1
(43) Pub. Date: Dec. 28, 2023

(54) Network Nodes and Methods in a Wireless Communications Network

(71) Applicant: Telefonaktiebolaget LM Ericsson (publ), Stockholm (SE)

(72) Inventors: Hasibur Rahman, Linköping (SE); Tobias Ahlström, Ljungsbro (SE); Stefan Engström, Linköping (SE)

(21) Appl. No.: 18/036,927

(22) PCT Filed: Nov. 16, 2020
(86) PCT No.: PCT/SE2020/051094

§ 371 Date: May 15, 2023

(51) Int. Cl. H04W 36/30; H04W 36/00

(52) U.S. Cl. CPC H04W 36/30; H04W 36/00835

(57) ABSTRACT

A method performed by a first network node for determining one or more cells to serve a wireless device connected to the first network node in a wireless communications network is provided. In a control connection between the first network node and a second network node, the first network node receives (1002) from the second network node, current load information for a third cell candidate, wherein the third cell candidate is served by a third network node. The first network node determines (1003) one or more cells to serve the wireless device based on the current load information of the third cell candidate.

### TECHNICAL FIELD

Embodiments herein relate to a first network node, a second and methods therein. In some aspects, they relate to determining one or more cells to serve a wireless device connected to the first network node in the wireless communications network.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a 5G network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to Radio Network Controllers (RNCs) used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

5G Radio Network Architecture

For 5G, 3GPP is working on a standardization of the 5th generation of mobile radio access systems, also called Next Generation Radio Access Network (NG-RAN). NG-RAN may include nodes which provide radio connection according to the NR standard, as well as nodes providing radio connection according to the LTE standard. NG-RAN nodes need to be connected to some network that provides non-access stratum functions and connection to communication networks outside NG-RAN, e.g. the Internet or other suitable networks. For NG-RAN nodes, the 5th Generation Core Network (5GC) is used. This is illustrated in FIG. 1 as CN nodes in 5GC i.e. Access and Mobility Management Function (AMF) and User Plane Function (UPF), interfacing gNBs, and eNBs using the NG interface (ng-eNBs), as specified by 3GPP. CN nodes, e.g. UPF or AMF, may communicate with the gNBs and NG-eNBs using the NG-interface and the gNBs and NG-eNBs communicate with other gNBs or NG-eNBs using the Xn interface.

5G using NR and NG-RAN is introduced as an evolution of the EPS which comprises EPC and E-UTRAN. The architecture of E-UTRAN, with interface to EPC, is illustrated in FIG. 2, which shows S1 interfaces for communication between eNBs and Mobility Management Entities (MMEs) and/or Serving Gateways (S-GWs). Further, illustrated in FIG. 2, the eNBs may communicate with other eNBs using the X2 interface.

Simultaneous Use of LTE and NR

To improve the connection for a wireless device, the wireless device can be connected simultaneously using NR and LTE. User data may then be sent using both respective Radio Access Technologies (RATs). Depending on which CN is used, either an eNB or a gNB can operate as a master node and can handle control signaling of the connection to the CN. This is illustrated in FIG. 3, where control signaling is depicted with a dotted line and user data is depicted with a dashed line. Further in FIG. 3, the CN is represented by EPC 300. An eNB 301 is serving an LTE cell operating as a master node and a gNB 302 is operating as a secondary node, both serving a UE 303. In this way, the gNB 302 serving an NR cell can be used in the network without using 5GC. Instead, as illustrated in FIG. 3, a combination of LTE and NR is deployed, also referred to as E-UTRAN-NR Dual Connectivity (EN-DC). The wireless device 303 is then connected to the EPC 303, simultaneously using both LTE and NR.

Another way to combine LTE and NR is when instead the gNB 302 operates as the master node and the eNB 301 operates as the secondary node which is referred to in 3GPP as NR-E-UTRA Dual Connectivity (NE-DC).

In these above deployments, not all cells, LTE or NR, will have similar capacity. For example, a high-band, mid-band, low-band, or most of the time combination of these may be used in an area to provide EN-DC or NE-DC. Different capacity means that a UE, e.g. UE 303, will get different throughput based on which of the above cells are currently being used for these operations. Throughput further depends on each cell's current available capacity, i.e., available radio resources.

Mobile Moving in a Network

A task of a RAN is to provide radio connections with good service for mobile wireless devices to be able to carry services that users want to utilize. Hence, it is central to find the most suitable cells or antenna beams for every wireless device as it moves around. This is today performed by the wireless device measuring strength and quality of radio signals from serving beams as well from neighbor beams. The results of the measurements are reported to the RAN, which takes a decision on what cells shall serve the mobile in the following. Measurements on a target cell provides information about possibility of cell access but also other information such as available capacity is useful to evaluate the expected throughput. For example, using EN-DC measurements as well as other information is useful for both LTE cells and NR cells that are possible to combine for a mobile wireless device. Further, this information is required for measuring NR coverage as illustrated in FIG. 4. In FIG. 4, control signaling is depicted with a dotted line and user data is depicted with a dashed line. Further in FIG. 4, a wireless device 404 is simultaneously using both an LTE cell and an NR cell served by an eNB 401 and a gNB 402a. The wireless device 404 in FIG. 4 is illustrated to move into a new LTE cell served by eNB 403 and can then also transition to use the NR cell provided by the gNB 402b.

In other scenarios, a wireless device may also be subject to moving to another cell even if it is stationary. This may be e.g. when the wireless device is arranged in a context of two eNBs and one gNB with overlapping coverage. In these scenarios, the cell managed by the gNB can be used for e.g. EN-DC or carrier aggregation.

Exchange of Cell Information Between RAN Nodes

When a connection is setup between two RAN nodes in E-UTRAN or NG-RAN, information is exchanged about served cells in the respective node. The information e.g. includes identities, frequency and bandwidth of served cells, as well as the neighbor cells of the served cell. For example, the bandwidth may be vital for certain services and a wireless device with such a service can only be moved to a cell with enough bandwidth. In a receiving node, the information may e.g. be used for a decision where to move a wireless device that is reaching the border of a serving cell or may be ending its connection.

In other scenarios, when the wireless device sets up a connection at a cell, the wireless device can be subject to one of many mobility actions including but not limited to: moving to an LTE cell where it can set up EN-DC, adding one or more cells as secondary cells for carrier aggregation, or even handover to another cell.

In E-UTRAN and NG-RAN cell information can be exchanged over the X2 or Xn connection, where the Xn requires a 5G Core. X2 is used between an eNB and a gNB and between an eNB and another eNB. This is exemplified in FIG. 5 which illustrates how information may be exchanged between an eNB 500a and an eNB 500b using an X2 connection. A first eNB 500a and a second eNB 500b performs a Resource Status Reporting procedure for exchange of served cell information between the first eNB 500a and the second eNB 500b. The first eNB 500a starts by initiating 501 a request. The first eNB 500a transmits 502 a resource status request to the second eNB 500b. The second eNB 500b receives the status resource request and transmits 503 a resource status response to the first eNB 500a. The first eNB 500a receives the resource status response transmitted by the second eNB 500b. Following these actions, the second eNB 500b transmits 504 to the first eNB 500a, a resource status update.

Traffic Load Status Update

Traffic load status of each cell can be exchanged between eNBs, between gNBs, and also between eNBs and gNBs. The traffic load status informs of current available capacity in any cell candidates, which indicates which cells has the capacity to provide better service to UEs, e.g. high throughput. Thus, when performing a mobility decision of whether or not to move a UE from one cell to another, it is thus vital that the UE is moved or stays at a cell that provides good service to the UE.

### SUMMARY

As a part of developing embodiments herein a problem was identified by the inventors and will first be discussed.

To decide whether or not to utilize a candidate cell, traffic load status information relating to the current load of the candidate cell is needed. Traffic load status information is obtained by network nodes exchanging traffic load status information of their respective served cells with their neighboring network nodes. Exchange of traffic load status information is performed by sending messages over a control connection, e.g. X2 or Xn connection between neighboring network nodes. This is however not always possible as a network node may not have a control connection e.g. an X2 or Xn interface, to another network node serving a candidate cell.

However, in order to best determine which cell improves the service of the wireless device, it is beneficial to know in advance, the traffic load status of the candidate cell before determining whether or not to utilize the candidate cell, e.g. whether or not to move the wireless device to the candidate cell or whether or not to use the candidate cell for Carrier Aggregation (CA), Dual Connectivity (DC), or Multi-Path TCP (MPTCP). If the traffic load status information for a candidate cell is not available, determining whether or not to utilize the candidate cell is therefore performed based on metrics which results in inefficient choices of cells to utilize, and consequentially, poor service for wireless devices.

Hence, an object of embodiments herein is thus to improve cell service provided to a wireless device in a wireless communications network.

According to an aspect of embodiments herein, the object is achieved by a method performed by a first network node for determining one or more cells to serve a wireless device connected to the first network node in a wireless communications network. In a control connection between the first network node and a second network node, the first network node receives from the second network node, current load information for a third cell candidate. The third cell candidate is served by a third network node. The first network node determines one or more cells to serve the wireless device based on the current load information of the third cell candidate.

According to another aspect of embodiments herein, the object is achieved by a method performed by a second network node for assisting a first network node in determining one or more cells to serve a wireless device connected to the first network node in a wireless communications network. In a control connection between the second network node and a third network node, the second network node receives from the third network node, current load information for the third cell candidate served by the third network node. The second network node assists the first network node in determining the one or more cells to serve the wireless device by transmitting to the first network node, the current load information for the third cell candidate as a basis for determining the one or more cells to serve the wireless device.

According to another aspect of embodiments herein, the object is achieved by a first network node configured to determine one or more cells to serve a wireless device connected to the first network node in a wireless communications network. The first network node is further configured to:
In a control connection between the first network node and a second network node, receive from the second network node, current load information for a third cell candidate, wherein the third cell candidate is arranged to be served by a third network node, and
determine one or more cells to serve the wireless device based on the current load information of the third cell candidate.

According to another aspect of embodiments herein, the object is achieved by a second network node configured to assist a first network node in determining one or more cells to serve a wireless device connected to the first network node in a wireless communications network. The second network node is further configured to:
in a control connection between the second network node and a third network node, receive from the third network node, current load information for the third cell candidate served by the third network node, and
assist the first network node in determining the one or more cells to serve the wireless device by transmitting to the first network node, the current load information for the third cell candidate adapted to be a basis for determining the one or more cells to serve the wireless device.

Since the first network node receives from the second network node, current load information for a third cell candidate served by a third network node, it is possible for the first network node to determine one or more cells to serve the wireless device based on the current load information of the third cell candidate. The first network node is thus able to determine the one or more cells to serve the wireless device based on information not otherwise available to the first network node, and thus improving the cell service for the wireless device as the first network node performs more informed decision on which one or more cells are to serve the wireless device.

### BRIEF DESCRIPTION OF THE DRAWINGS

Examples of embodiments herein are described in more detail with reference to attached drawings in which:

FIG. 1 is a schematic block diagram illustrating prior art.

FIG. 2 is a schematic block diagram illustrating prior art.

FIG. 3 is a schematic block diagram illustrating prior art.

FIG. 4 is a schematic block diagram illustrating prior art.

FIG. 5 is a sequence diagram illustrating prior art.

FIG. 6 is a schematic block diagram illustrating prior art.

FIG. 7 is a schematic block diagram illustrating prior art.

FIG. 8 is a schematic block diagram illustrating prior art.

FIG. 9 is a schematic block diagram illustrating embodiments of a wireless communications network.

FIG. 10 is a flowchart depicting embodiments of a first network node.

FIG. 11 is a flowchart depicting embodiments of a second network node.

FIG. 12 is a schematic block diagram illustrating embodiments herein.

FIG. 13 is a sequence diagram depicting embodiments herein.

FIG. 14 is a sequence diagram depicting embodiments herein.

FIG. 15 is a schematic block diagram illustrating embodiments herein.

FIG. 16a-b are schematic block diagrams illustrating embodiments of a first network node.

FIG. 17a-b are schematic block diagrams illustrating embodiments of a second network node.

FIG. 18 schematically illustrates a telecommunication network connected via an intermediate network to a host computer.

FIG. 19 is a generalized block diagram of a host computer communicating via a base station with a user equipment over a partially wireless connection.

FIGS. 20-23 are flowcharts illustrating methods implemented in a communication system including a host computer, a base station and a user equipment.

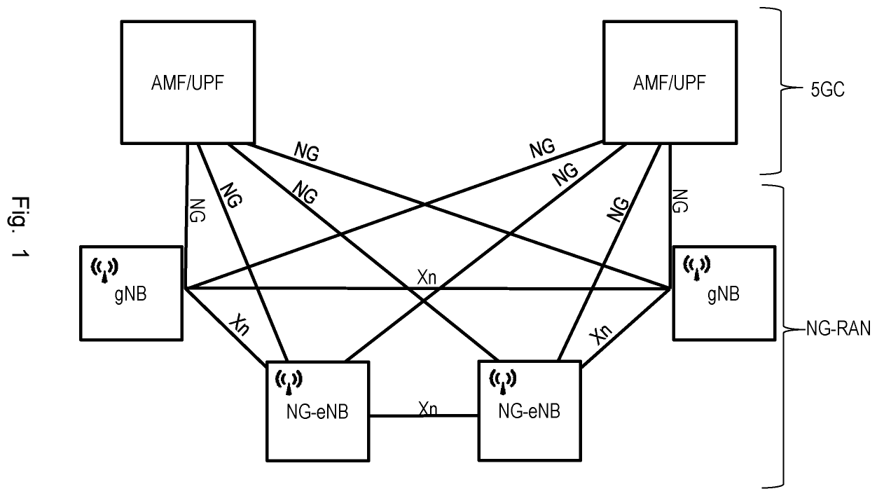

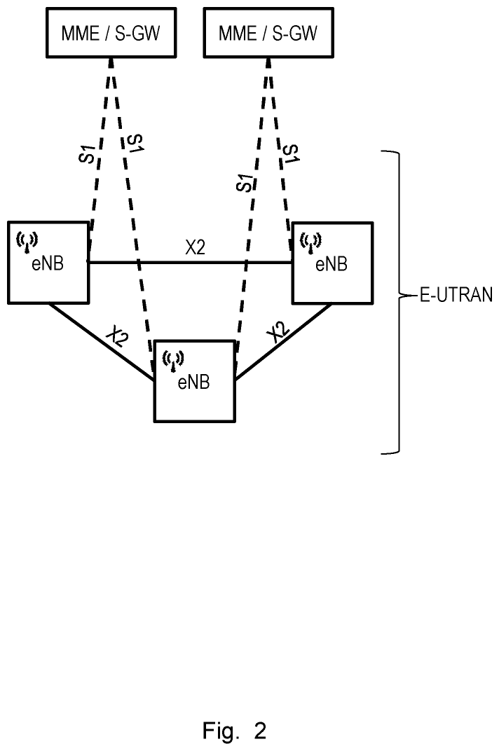

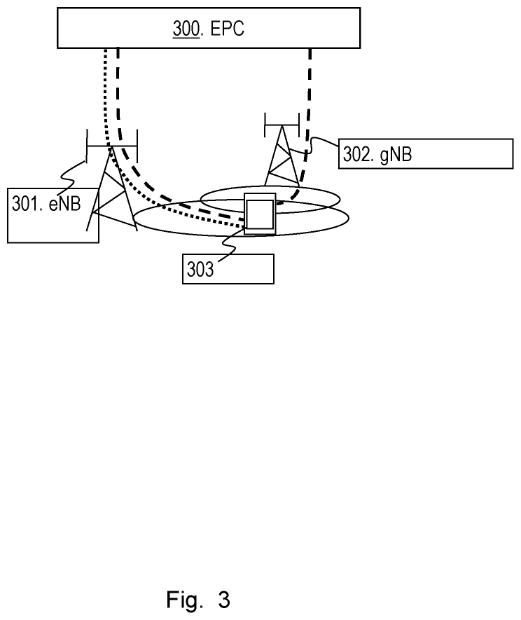

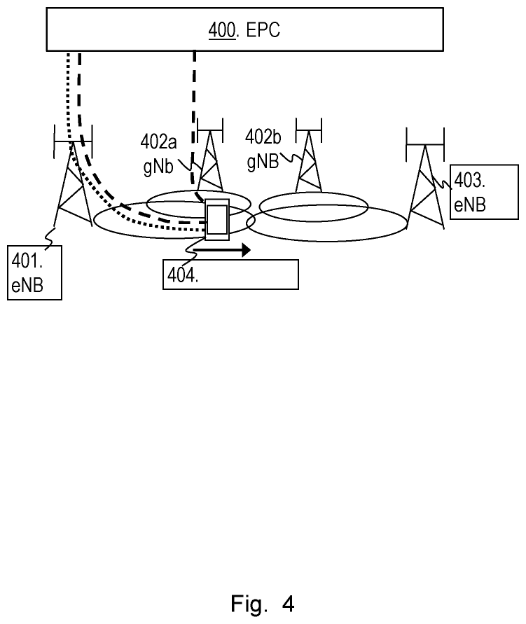

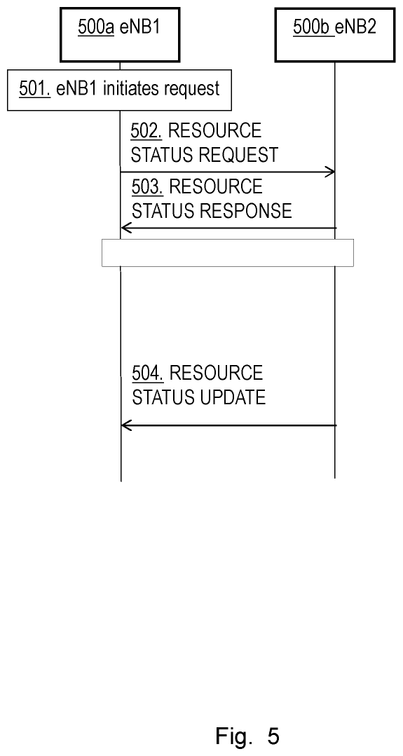

### DETAILED DESCRIPTION

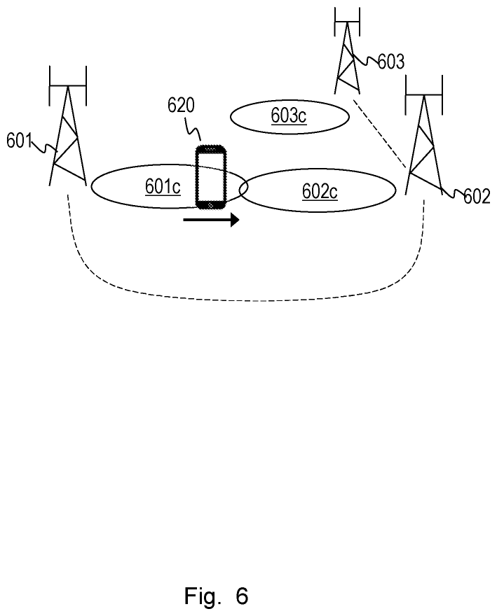

FIGS. 6-8 further illustrates problem scenarios identified by the inventors as part of developing embodiments herein and will first be discussed. FIG. 6 illustrates a first network node 601 serving a first cell 601c, a second network node 602 serving a second cell 602c, and a third network node 603 serving a third cell 603c. Control connections are illustrated in FIG. 6 as dashed lines, wherein there is a control connection between the first network node 601 and the second network node 602 and there is another control connection between the third network node 603 and the second network node 602. When a wireless device 620 in the first cell 601c connected to the first network node 601, decides to utilize, e.g. moves into, the second cell 602c and the third cell 603c, the first network node 601 can thus only obtain traffic load status from the second network node 602 about the second cell 602c, and hence, the first network node 601 will not be able to determine which of the cells 601c, 602c, 603c, alone or in combination, provides the best service to the wireless device 620. Hence, the first network node 601 makes an uninformed decision of where to handover the wireless device 620, which may cause poor cell service to the wireless device 620, and furthermore may further demand moving the wireless device 620 several times to find a cell with sufficient service, thus unnecessarily increasing network load.

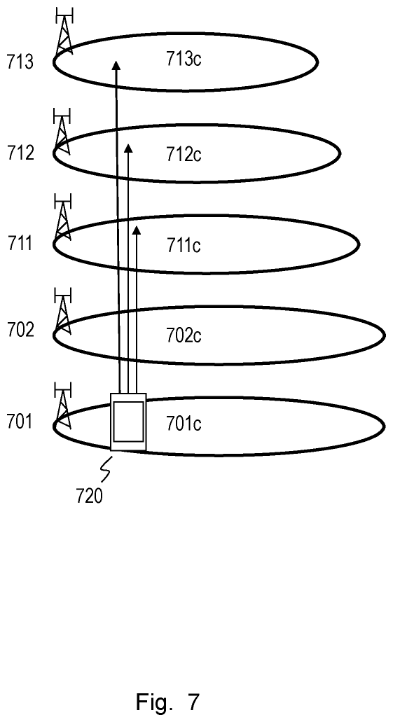

An eNB may report traffic load status of associated LTE cells by using Resource Status Reporting procedures as standardized in 3GPP TS 36.423, chapters 8.3.6, 8.3.7, and 9.1.2.11-9.1.2.14. However, this can only be used for LTE resource information and only between eNBs. Hence, a first eNB cannot inform its neighbor eNBs about the first eNBs neighbor NR cells' traffic load information, nor can the first eNB inform about which LTE layers to use or not to use for DC with NR, and furthermore cannot exchange information over X2 with a gNB about an NR cell. This problem is illustrated in FIG. 7 where a wireless device 720 is served in an LTE cell in a first eNB 701. The first eNB 701 does not have any associated NR cell, but can move the wireless device 720 to use NR cells such as any of: a lowband NR cell 711c provided by a gNB 711, a midband NR cell 712c provided by a gNB 712, and a highband NR cell 713c provided by gNB 713. The first eNB 701 cannot exchange load information with gNBs 711, 712, 713, but can exchange information with a second eNB 702. The second eNB 702 is associated with the NR cells 711c, 712c, 713c and can exchange information with both the first eNB 701 and the gNBs 711, 712, 713. When the first eNB 701 needs to make a mobility decision e.g. for handover from LTE to NR, or handover for EN-DC service, such as transitioning the wireless device 720 from the first eNB 701 to an NR cell 711c, 712c, 713c or to another eNB 702. When determining which cells to utilize, e.g. it may be preferable to move the NR capable wireless device 720 to a highband NR cell 713c to improve the throughput for the wireless device 720. However, if the highband NR cell 713c is already highly loaded, this leads to an inefficient traffic steering where the wireless device 720 might not get desired good service, e.g. higher throughput, and to counter this, the wireless device 720 may again need to be moved to another NR cell to get better throughput. Hence, this results in inefficient mobility decisions and will degrade throughput as well as time to get NR service. Therefore, in these cases, the traffic load status of candidate NR cells 711c, 712c, 713c, or load on the NR cells 711c, 712c, 713c in an EN-DC context when aggregating an NR cell with the second eNB 702 need to be considered for achieving best service for the wireless device 720. In a similar way, this also applies for scenarios when using NR cells as secondary cells for CA.

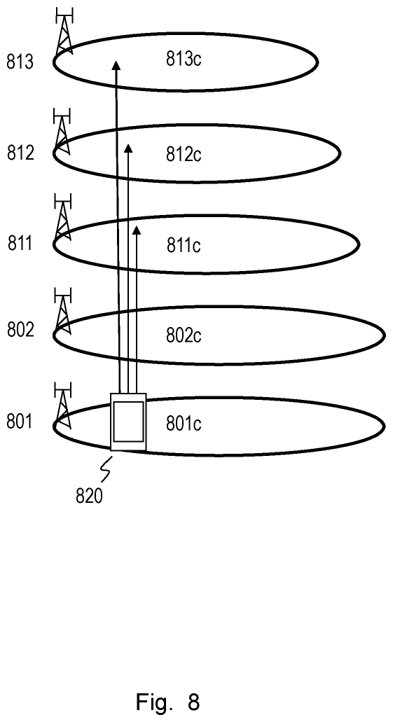

Similarly, FIG. 8, demonstrate the example from a gNB perspective. A first gNB 801 is connected to a wireless device 820. The first gNB 801 is not associated, with any LTE cell, but can move the wireless device 820 to LTE cells 811c, 812c, 813c. The first gNB 801 cannot exchange any information with eNBs 811, 812, 813 providing the cells 811c, 812c, 813c, but is connected with a second gNB 802 which it can exchange load information with. The second gNB 802 is associated with the LTE cells 811c, 812c, 813c and can exchange load information with both the first gNB 801 and the eNBs 811, 812, 813. The eNB 813 provides an LTE high capacity cell 813c which has a high load. The eNB 812 provides an LTE medium capacity cell 812c which has a low load. The eNB 811 provides an LTE low capacity cell 811c which has a medium load. Hence, the first gNB 801 may, without load information consider moving the wireless device 820 to the LTE high capacity cell 813, which, due to the high load, is not preferred and is an inefficient choice of cell. Instead, the LTE cells 811c, 812c are preferred cells and would be considered candidate cells if load information were available and taken in consideration for the cell determination.

The problem further extends beyond only base stations, as it also relates to neighboring WiFi cells of the sending node e.g. when exchanging load information between eNBs or gNBs, wherein WiFi cells may be co-located with the above LTE or NR cells, and also relates to any system wherein network nodes are lacking a direct control connection.

As mentioned above, an object of embodiments herein is thus to improve cell service provided to a wireless device in a wireless communications network.

This is e.g. performed by embodiments herein, by utilizing a second network node, which has separate control connections, a control connection to the first network node and another control connection to the third network node. The second network node transmits, to the first network node, traffic load information relating to a third cell provided by the third network node. In this way, the second network node may assist the first network node by forwarding traffic load information from the third network node to the first network node even when the first network node and the third network node has no direct control connection.

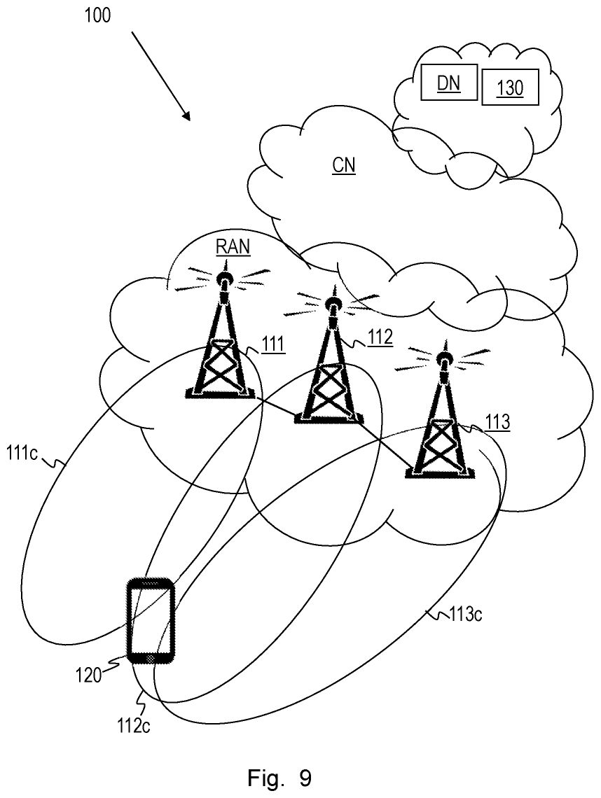

Embodiments herein relate to wireless communication networks in general. FIG. 9 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, LTE, LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMAX), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g. a first network node 111, a second network node 112, and a third network node 113. These nodes provide radio coverage in a number of cells which may also be referred to as a beam or a beam group of beams. The first network node 111 provides a first cell 111c. The second network node 112 provides a second cell candidate 112c. The third network node 113 provides a third cell candidate 113c.

The first network node 111, the second network node 112, and the third network node 113 may according to embodiments herein e.g. be acting as a master node or a secondary node when serving a wireless device 120 in the wireless communications network 100. In these embodiments, the cell 111c, and cell candidates 112c, 113c may respectively serve as a primary cell or a secondary cell.

The first network node 111, the second network node 112, and the third network node 113 may each be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an eNB, a gNB, a base transceiver station, a radio remote unit, an Access Point Base Station, a base station router, a transmission arrangement of a radio base station, a stand-alone access point or any other network unit capable of communicating with a wireless device within the service area such as cells 111c, 112c, 113c provided by the respective network nodes 111, 112, 113.

The first network node 111 and the second network node 112 may have a control connection for communicating e.g. load information of the second candidate cell 112c and/or the third candidate cell 113c. The second network node 112 and the third network node 113 may have a control connection for communicating e.g. load information of the third candidate cell 113c.

The first network node 111, the second network node 112, and the third network node 113 may be referred to as serving network nodes and communicate with the wireless device 120 with Downlink (DL) transmissions to the wireless device 120 and Uplink (UL) transmissions from the wireless device 120.

One or more wireless devices operate in the wireless communication network 100, such as e.g. the wireless device 120. The wireless device 120 may also be referred to as a device, an IoT device, a mobile station, a non-access point (non-AP) STA, an STA, a UE and/or a wireless terminal. The wireless device 120 communicates via one or more Access Networks (AN), e.g. RAN, to one or more CN. It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

Methods herein may be performed by the first network node 111 and the second network node 112. As an alternative, a Distributed Node (DN) and functionality, e.g. comprised in a cloud 130 as shown in FIG. 9, may be used for performing or partly performing the methods herein.

The above described problem is addressed in a number of embodiments, some of which may be seen as alternatives, while some may be used in combination.

Examples of embodiments herein provides advantages such as e.g. the following:

When moving the wireless device 120, e.g. handover, handoff, or other traffic control procedures, to a new cell, or assigning additional cells to the wireless device 120, it is thus possible to avoid highly loaded and overloaded cells. The wireless device 120 may instead be moved to, or be assigned cells, e.g. cell 112c or 113c, which may provide better service to the wireless device, e.g. higher bitrate, higher throughput, lower jitter, and reduced traffic.

Furthermore, embodiments herein may also improve the service of other wireless devices. This is since other wireless devices already using a highly loaded cell will in this way not have to share scarce resources of the highly loaded cell with the wireless device 120. Also, as a cell with the best service for the wireless device 120, e.g. cells 111c, 112c, 113c, may be determined in advance of e.g. performing a mobility decision, this may reduce the need to later on having to adjust which cells serve the wireless device 120 and in this way reduce network load. As will be further explained, the embodiments herein also apply to a wide range of scenarios and use-cases.

In some embodiments, the first network node 111 may now know about traffic load status of NR and/or WiFi cells, e.g. the cell 112c, and/or the cell 113c, directly neighboring and neighboring the neighbors of the first network node 111, and may thus make a better decision about these cells 112c 113c, e.g. for mobility procedures or CA purposes or DC purposes. The first network node 111 may be an eNB operating in EN-DC mode. Thus, in some scenarios, when the first network node 111 need to make a mobility decision, the first network node 111 may steer the wireless device 120 to an NR cell, e.g. cell 112c or cell 113c, providing best service based at least partially on the NR cell load information, e.g. cell utilization of the NR cell. The NR cell load information may further be used as a basis for determining when the first network node 111 may assign an additional cell to the wireless device 120, e.g. cell 112c in the second network node 112 or cell 113c in the third network node 113, to aggregate NR throughput, e.g. CA or DC possibilities with the target network node.

Embodiments herein is also be applicable for NE-DC scenario when the first network node 111 may now benefit from knowing LTE cell traffic load information of its neighboring network node, e.g. network node 112, and network nodes neighboring its neighboring network nodes, e.g. network node 113. The first network node may now have load information of LTE cells, e.g. cell 112c and/or 113c, which may further be used as a basis for mobility decisions when determining whether or not to move the wireless device 120 from NR to LTE. Some scenarios, e.g. due to poor coverage in an NR cell, e.g. cell 111c, may require the first network node 111 to move the wireless device 120 to an LTE cell, e.g. cell 112c or 113c, to maintain a stable connection with good service for the wireless device 120.

Similar to above, by exchanging traffic load information of WiFi cells, e.g. cell 112c and/or cell 113c, between network nodes, e.g. the first network node 111 and the second network node 112, the wireless device 120 may be offloaded from the first network node 111 to a WiFi cell, e.g. the cell 112c or the cell 113c, based on the traffic load of said WiFi cell and/or based on other load information of any of cells 111c, 112c, and 113c.

Embodiments herein may be applicable to any intra-system or inter-system, intra-RAT or inter-RAT scenario where some network nodes 111, 112, 113, do not have a control connection, e.g. X2 or Xn interface, to another network node 111, 112, 113, e.g. due to unconnected control signalling networks or node link capacity shortage. In this way, embodiments herein thus improve the service for wireless devices such as the wireless device 120, by e.g. improving CA for higher throughput and/or improving mobility decisions based on previously unavailable traffic load information.

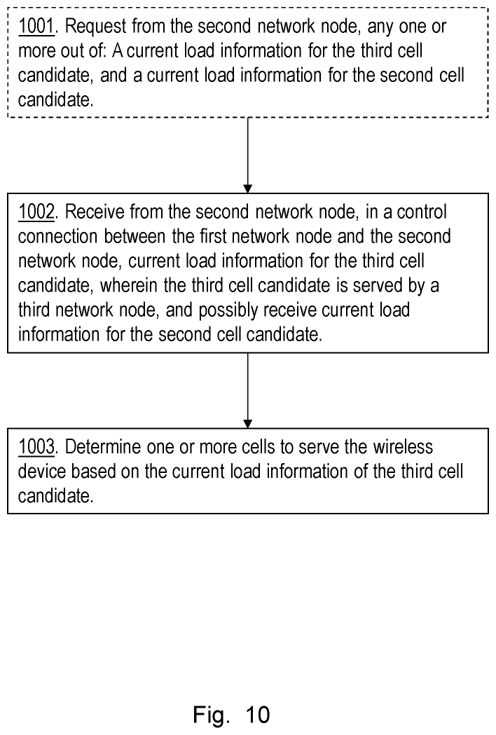

FIG. 10 shows example embodiments of a method performed by the first network node 111 for determining one or more cells to serve the wireless device 120 connected to the first network node 111 in the wireless communications network 100.

In an example scenario, there is a control connection between the first network node 111 and the second network node 112, and there is another control connection between the third network node 113 and the second network node 112. However, there is no control connection between the first network node 111 and the third network node 113.

The method comprises the following actions, which actions may be taken in any suitable order. Optional actions are referred to as dashed boxes in the Figure.

Action 1001

In some embodiments, the first network node 111 requests from the second network node 112, any one or more out of: a current load information for the third cell candidate 113c, and a current load information for the second cell candidate 112c. This may be to obtain current load information from the second candidate cell 112c or the third candidate cell 113c in order to select one or more cells to serve the wireless device 120 based on the current load information. Since, there is no control connection between the first network node 111 and the third network node 113, the load information of the third network node 113 is not directly available to the first network node 111. However, the second network node 112 may, e.g. on request, collect the load information of the third candidate cell 113c for the first network node 111, e.g. by exchanging load information with the third network node 113 and then send it to the first network node 111 on the control connection. The first network node 111 may obtain the current load information for the third cell candidate 113c, and/or the second cell candidate 112c upon request or without requesting it from the second network node 112.

Action 1002

According to the example scenario, to be able to determine the best cell to serve the wireless device 120, the first network node 111 may need load information of cell candidates such as the third cell candidate 113c, even if it has no control connection to the third network node 113 serving the third cell candidate 113c. According to embodiments herein, the first network node 111 may receive this load information with assistance of the second network node 112 that has a control connection to the third network node 113. The second network node 112 has a control connection to the third network node 113 and is capable of collecting the load information and then forward it to the first network node 111 over the control connection between the first network node 111 and the second network node 112.

The first network node 111 may also further need load information of cell candidates having a control connection between the first network node 111 and network nodes serving the cell candidates.

The first network node 111 receives current load information for the third cell candidate 113c from the second network node 112. This is received in a control connection between the first network node 111 and the second network node 112. The third cell candidate 113c is served by the third network node 113. Note that there is no control connection between the first network node 111 and the third network node 113.

As mentioned above, load information may be received upon request or without requesting it from the second network node 112.

In some embodiments, the first network node 111 further receives current load information for the second cell candidate 112c from the second network node 112. Thus, cell service provided to the wireless device 120 may be further improved as the first network node 111 is in this way enabled to determine the one or more cells to serve the wireless device 120 further on the basis of the second cell candidate 112c.

Action 1003

The first network node 111 then determines one or more cells to serve the wireless device 120 based on the current load information of the third cell candidate 113c. In this way, it may thus be possible for the network node 111 to determine one or more cells to serve the wireless device 120 based on traffic load information of cells provided by network nodes without a control connection to the first network node 111. Thus, in some scenarios when the third cell candidate 113c is the most suitable cell to serve the wireless device 120 based on the load information such as e.g. cell capacity, used capacity, or free capacity. Another cell, e.g. the second cell candidate 112c, may now be determined to be the most suitable to serve the wireless device 120, as the load information of the third cell candidate 113c may indicate a high load in the third cell candidate 113c.

In some embodiments, the first network node 111 determines the one or more cells to serve the wireless device 120, further based on the current load information for the second cell candidate 112c. In some embodiments, it may be possible to determine which one or more cells out of the second candidate cell 112c and the third candidate cell 113c, e.g. which cell that best improves the cell service when serving the wireless device 120. Furthermore, in this way, it may also be possible to determine the one or more cells that may best provide service for use in, e.g. CA, DC, MPTCP.

In some embodiments, the first network node 111 determines the one or more cells to serve the wireless device 120, by determining the one or more cells to serve the wireless device 120 as any one or more out of: a primary cell and a secondary cell. In other words, the first network node 111 may determine the one or more cells to serve the wireless device 120 as a primary cell and/or as a secondary cell.

The serving of the wireless device 120 is performed by use any one out of: CA, DC, and MPTCP. In other words, the wireless device 120 may be served in the determined one or more cells in CA, DC, or MPTCP.

In this way, it may be possible for the first network node 111 to determine the one or more cells which best improves the service of the wireless device 120 when aggregating any two of the first cell 111c, the second cell candidate 112c, and the third cell candidate 113c used as a primary or secondary cell. Aggregation may be performed using CA, and the determined one or more cells may be configurated to use any form of DC, e.g. EN-DC, NE-DC or NR-DC.

In some embodiments, the first network node 111 determines the one or more cells to serve the wireless device 120, by determining the third cell candidate 113c to serve as any of: a primary cell, or a secondary cell, when the current load information for the third cell candidate 113c indicates a low load. In this way, it may be possible for the first network node 111 to determine which one or more cells are to serve as a primary cell, or secondary cell, based on the load information of the third cell candidate 113c. E.g. the first network node 111 may now be enabled to determine if the third cell candidate 113c is to serve as a primary cell or a secondary cell. Determining that a cell, e.g. the third cell candidate 113c, is to serve as a secondary cell, may also in some scenarios imply the determination of which cell is to serve as a primary cell, e.g. the second candidate cell 112c may then be determined to be the primary cell. E.g. in EN-DC mode, the third candidate cell 113c may be an NR cell of high capacity and low load and may be available to serve as a secondary cell when the second cell candidate 112c is serving as a primary cell. The second cell candidate 112c may be an LTE cell with higher load than the first cell 111c. Using the knowledge of the load information of the third candidate cell 113c, it may thus be possible to determine that in order to improve the cell service of the wireless device 120, the second candidate cell 112c may serve as a primary cell and the third candidate cell 113 may serve as a secondary cell.

In some embodiments, the determination of the one or more cells may relate to any suitable mobility decision or traffic control procedure. Thus, in these embodiments, the first network node 111 determines the one or more cells to serve the wireless device 120, by any one out of: Determining the one or more cells to serve the wireless device 120 after a handover of the wireless device 120 to the determined one or more cells, and determining the one or more cells to serve the wireless device 120 after a redirection of the wireless device 120 to one of the determined one or more cells. The first network node 111 may in this way determine which one or more cells is better to perform a handover to, e.g. based on the received load information of the third candidate cell 113c.

The first network node 111 may also release and redirect wireless device 120 to the third cell candidate 113c, e.g. to be used as a primary cell In some embodiments the communications network 100 is represented by a wireless multi RAT communications network. In these embodiments the connection between the first network node 111 and the wireless device 120 is connected using a first RAT, and any one or more out of: the third cell candidate 113c uses a third RAT different from the first RAT, and the second cell candidate 112c uses a second RAT different from the first RAT. According to some embodiments herein it may thus be possible to determine the one or more cells, e.g. based on load information of the cells, communicating using different RATs. E.g. the first network node 111 may be an eNB and the first cell 111c an LTE cell, and at the same time, the second candidate cell 112c and the third candidate cell 113c may respectively be any one out of: an LTE cell, NR cell, Wi-Fi cell or WCDMA cell.

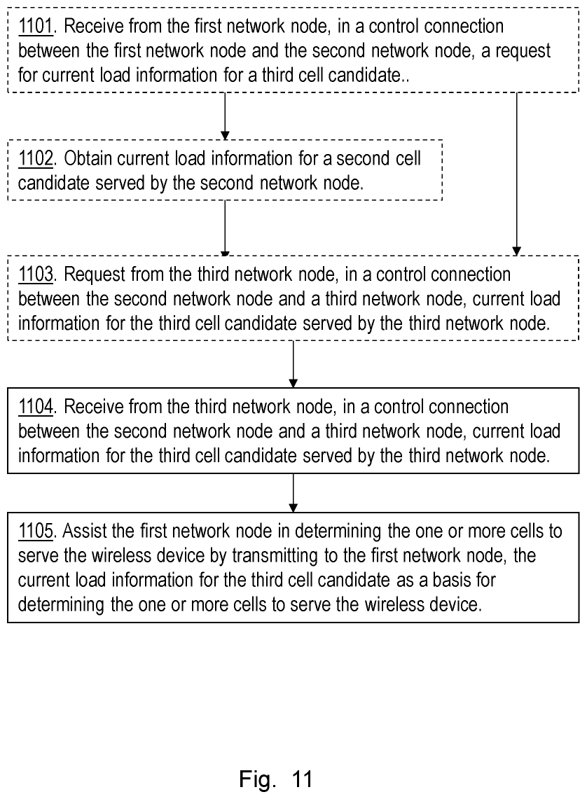

FIG. 11 shows example embodiments of a method performed in the second network node 112 for assisting a first network node 111 in determining one or more cells to serve the wireless device 120 connected to the first network node 111 in the wireless communications network 100. In an example scenario, there is a control connection between the first network node 111 and the second network node 112, and there is another control connection between the third network node 113 and the second network node 112. However, there is no control connection between the first network node 111 and the third network node 113.

The method comprises the following actions, which actions may be taken in any suitable order. Optional actions are referred to as dashed boxes in FIG. 11.

Action 1101

According to the example scenario, to be able to determine the best cell to serve the wireless device 120, the first network node 111 may need load information of cell candidates such as the third cell candidate 113, even if it has no control connection to the third network node 113 serving the third cell candidate 113c.

In some embodiments, the second network node 112 may receive a request for current load information for a third cell candidate 113c from the first network node 111. The request may be received in a control connection between the first network node 111 and the second network node 112.

In some embodiments, the second network node 112 may receive from the first network node 111, a request for current load information for a second cell candidate 112c served by the second network node 112. In these embodiments, the second network node 112 may provide both the load information of the second cell candidate 112c and the third cell candidate 113c.

Action 1102

In some embodiments, the second network node 112 obtains current load information for a second cell candidate 112c served by the second network node 112. This may be e.g. recording the number of connected wireless devices, the amount of occupied air interface resources or the number of free air interface resources.

Action 1103

In some embodiments, the second network node 112 may request current load information for the third cell candidate 113c served by the third network node 113 from the third network node 113. The request may be sent in a control connection between the second network node 112 and the third network node 113. The request may e.g. be a request to exchange load information between the second network node 112 and the third network node 113. The request may be a resource status request for an NR cell or an LTE cell.

Action 1104

The second network node 112 receives current load information for the third cell candidate 113c served by the third network node 113 from the third network node 113. The current load information for the third cell candidate 113c is received in a control connection between the second network node 112 and a third network node 113.

Action 1105

The second network node 112 then assists the first network node 111 in determining the one or more cells to serve the wireless device 120. This is performed by transmitting to the first network node 111, the current load information for the third cell candidate 113c as a basis for determining the one or more cells to serve the wireless device 120. Due to the assistance of the second network node 112, it may thus be possible for the network node 111 to determine which one or more cells will serve the wireless device based on traffic load information of the third candidate cell 113c.

In some embodiments, the second network node 112 assists the first network node 111 in determining the one or more cells to serve the wireless device 120 by further transmitting to the first network node 111, the current load information for the second cell candidate 112c as a further basis for determining the one or more cells to serve the wireless device 120. In this way, due to the assistance of the second network node 112, it may thus be possible for the network node 111 to determine which one or more cells will serve the wireless device based on traffic load information of both the second candidate cell 112c and third candidate cell 113c.

In some embodiments the second network node 112 assists the first network node 111 in determining the one or more cells to serve the wireless device 120 as any one or more out of: a primary cell and a secondary cell, and wherein serving the wireless device 120 is performed by use any one out of: CA, DC, and MPTCP. This is to make it possible for the first network node 111 to determine the one or more cells which best improves the service of the wireless device 120 when aggregating any two of the first cell 111c, the second cell candidate 112c, and the third cell candidate 113c using a primary and a secondary cell. Aggregation may be performed using CA, and the determined one or more cells may be configurated to use any form of DC, e.g. EN-DC, NR-DC or NE-DC.

In some embodiments, the second network node 112 assists the first network node 111 in determining the third cell candidate 113c to serve as any of: a primary cell, or a secondary cell, when the current load information for the third cell candidate 113c indicates a low load. In these embodiments, it may thus be possible for the first network node 111 to determine the one or more cells to be a secondary cell, or primary cell, based on the load information of the third cell candidate 113c.

In some embodiments the determination of the one or more cells may relate to any suitable mobility decision or traffic control procedure, e.g. decisions relating to most suitable cells for a handover, CA, or DC. Determining the one or more cells may thus relate to whether or not to handover the wireless device 120 to a different node and candidate cell. Therefore, the network node 112 may assist the first network node 111 in determining the one or more cells to serve the wireless device 120 after a handover of the wireless device 120 to the determined one or more cells. The determining of the one or more cells may also relate to whether or not to release and redirect the wireless device 120 e.g. determining to use another cell as primary cell. The network node 112 may therefore also assist the first network node 111 in determining the one or more cells to serve the wireless device 120 after a redirection of the wireless device 120 to one of the determined one or more cells.

In some embodiments, the communications network 100 is represented by a wireless multi RAT communications network and wherein the connection between the first network node 111 and the wireless device 120 is connected using a first RAT, and wherein any one or more out of: the second cell candidate 112c uses a second RAT different RAT from the first RAT, and the third cell candidate 113c uses a third RAT different from the first RAT. Hence, in this way, similar to actions for the first network node 111 above, it may thus be possible to determine the one or more cells, e.g. based on load information of the cells, communicating using different RATs.

The above embodiments will now be further explained and exemplified below. The embodiments below may be combined with any suitable embodiment above.

Forwarding Traffic Load Information

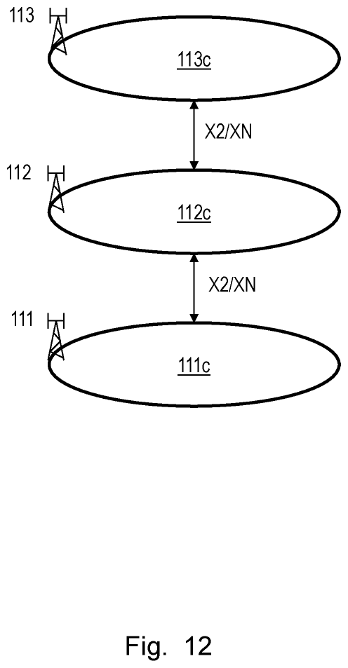

The above disclosed embodiments are relevant for any system that may benefit of intra-system or inter-system load information where there is no direct connection, e.g. X2 or Xn connection, between network nodes as illustrated in an example scenario in FIG. 12. FIG. 12 depicts the first network node 111 providing the cell 111c, e.g. which may be an eNB or a gNB, that does not have a connection, e.g. X2 or Xn connection, with the third network node 113 providing the third candidate cell 113c. The second network node 112 provides the second cell candidate 112c and has two separate connections, e.g. X2 or XN connections, one connection to the first network node 111 and one connection the third network node 113. The second network node 112 may then forward the load information of cell 113c of the third network node 113 and the load information of the cell 112c to the first network node 111. The first network node 111 may then use the third cell 113c as for e.g. CA, DC, or mobility purposes such as handover to the third cell 113c, or both.

By receiving and using the load information, to determine which cells to use for CA or mobility purposes, the first network node 111 may make a more efficient decision of e.g. CA or handover as the load of e.g. highly loaded cells may be considered when determining which cells to utilize. This may thus lead to better service for wireless devices, e.g. wireless device 120, as they have to share highly loaded cells to a lesser extent. Furthermore, as a cell, e.g. the cell 112c or the cell 113c, that is providing good cell service, e.g. high throughput, low latency, low jitter, may initially be determined, this reduces the need to re-adjust a mobility decision, e.g. having to perform one or more additional mobility decisions for wireless devices due to poor service as a result of inefficiently selecting a highly loaded cell for handover, and hence, reduces network load. When using CA, the purpose of using secondary cells may be to provide increased throughput, hence, the first network node 111 may now select a cell that is not overloaded for better throughput as a secondary cell.

eNB Communication

The above embodiments will now be further explained and exemplified in embodiments relating to methods herein performed by eNBs.

The above embodiments may be applied to following example scenarios when an eNB may need to perform NR load-aware mobility decisions such as:
Moving a wireless device, e.g. the wireless device 120, from an LTE cell, e.g. cell 111c, which cannot provide EN-DC service to another LTE cell, e.g. any of: cell 112c, and 113c, where EN-DC service may be provided and may provide better throughput with an NR cell e.g. any of: cell 112c, and cell 113c. To setup an NR leg for EN-DC, one or more NR cells, e.g. any of cells 112c, and 113c, may need to be configured to allow non-EN-DC capable LTE network nodes, e.g. network node 111, to move the wireless device to an EN-DC capable LTE cell, e.g. any of: cell 112c, and 113c, where it may select NR cells, e.g. any of: cell 112c, and 113c, that are less loaded to ensure a better service for the wireless device. This may in some scenarios also reduce any potential NR cell change from the EN-DC capable LTE cell if the one or more NR cells, e.g. any of: cell 112c, and 113c, is highly loaded and cannot meet the requirement to provide higher throughput.
In a connected mode, from an LTE cell, e.g. cell 111c, to an NR cell, e.g. cell 112c or 113c, perform a handover, or perform a Release with Redirect to achieve better service in a wireless device, e.g. the wireless device 120.
Determining for NR, a secondary cell group for a wireless device, e.g. the wireless device 120, NR cells which are not over-loaded.
For carrier aggregation using NR leg, e.g. with any of cells 112c or 113c.

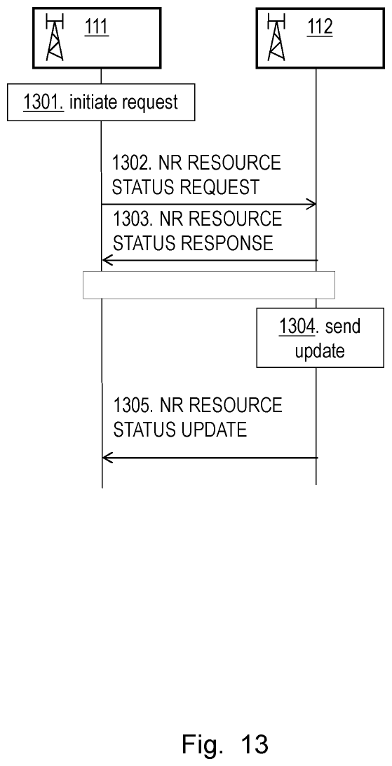

FIG. 13 illustrates an example scenario where the first network node 111 requests from the second network node 112 traffic load information, e.g. as a status update, using a set of example messages presented below. The messages below are examples and may be renamed with same functionality in any suitable manner. In the example scenario of FIG. 13, the first network node 111 is an eNB and the second network node 112 is an eNB.

In the example scenario of FIG. 13, the first network node 111, may not have any associated NR cell, e.g. cell 113c. Hence, the first network node 111 may need to request NR resource status from a neighboring eNB such as the second network node 112. The first network node 111 thus initiates 1301 a request and transmits 1302 an NR resource status request to the second network node 112. The second network node 112 may then respond by transmitting 1303 to the first network node 111, an NR resource status response. Further, the second network node 112, may then periodically send 1304 updates to the first network node 111, which may involve transmitting 1305 an NR resource status update message. The periodic update may further be configured to trigger every set time interval such as e.g. every 100 ms, 1 s, 2 s, 10 s, 30 s, or 60 s, or when ever the load has changed a specified amount, e.g. 5% or 10 Mbit/s or 100 physical resource blocks/10 ms, up or down.

Currently in the 3GPP standard, 36.423, chapters 9.1.2.3, 9.1.2.4, 9.1.2.8, 9.1.2.31, 9.1.2.32, 9.1.2.34, it may be possible to exchange some NR cell information, e.g., the NR cell id, between eNBs via a neighbor information NR Information Element (IE). In this way, an eNB, e.g. the first network node 111, may be enabled to include an NR cell id when requesting NR traffic load status in embodiments herein.

NR Resource Status Request

The below table illustrates an example NR RESOURCE STATUS REQUEST message. In some scenarios, the exemplified eNB1 may be the first network node 111, and the exemplified eNB2 may be the second network node 112.

In some embodiments, in addition to NR traffic information load, radio resource status, other load information such as specified in the table below may also be shared. Traffic load may be quantified by specifying any one or more out of: Physical Resource Blocks (PRB) usage, number of active UEs, number RRC connected UEs.

Direction: eNB1→eNB2.

| | | | IE type and | | | Assigned |
|---|---|---|---|---|---|---|
| IE/Group Name | Presence | Range | reference | Semantics description | Criticality | Criticality |
| Message Type | M | | | | YES | reject |
| eNB1 | M | | INTEGER | Allocated by eNB₁ | YES | reject |
| Measurement ID | | | (1 . . . 4095, . . . ) | | | |
| eNB2 | C- | | INTEGER | Allocated by eNB₂ | YES | ignore |
| Measurement ID | ifRegistration | | (1 . . . 4095, . . . ) | | | |
| | Request | | | | | |
| | Stopor | | | | | |
| | PartialStopor | | | | | |
| | Add | | | | | |
| Registration | M | | ENUMERATED | Type of request for which the | YES | reject |
| Request | | | (start, | resource status is required. | | |
| | | | stop, . . . , | | | |
| | | | partial | | | |
| | | | stop, add) | | | |
| Report | O | | BITSTRING | Each position in the bitmap | YES | reject |
| Characteristics | | | (SIZE(32)) | indicates measurement | | |
| | | | | object the eNB₂ is requested | | |
| | | | | to report. | | |
| | | | | First Bit = PRB Periodic, | | |
| | | | | Second Bit = TNL load Ind | | |
| | | | | Periodic, | | |
| | | | | Third Bit = HW Load Ind | | |
| | | | | Periodic, | | |
| | | | | Fourth Bit = Composite | | |
| | | | | Available Capacity Periodic, | | |
| | | | | this bit should be set to 1 if at | | |
| | | | | least one of the First, Second | | |
| | | | | or Third bits is set to 1, | | |
| Cell To Report | | 1 | | Cell ID list to which the | YES | ignore |
| | | | | request applies. | | |
| >Cell To | | 1 . . . <max | | | EACH | ignore |
| Report Item | | neighbour | | | | |
| | | NR cells | | | | |
| | | in eNB> | | | | |
| >>Cell ID | M | | NR CGI | | — | |
| | | | (NR Cell | | | |
| | | | Global | | | |
| | | | Identifier) | | | |
| Reporting | O | | ENUMERATED | Periodicity that can be used | YES | ignore |
| Periodicity | | | (1000 ms, | for reporting of PRB Periodic, | | |
| | | | 2000 ms, | TNL Load Ind Periodic, HW | | |
| | | | 5000 ms, | Load Ind Periodic, Composite | | |
| | | | 10000 ms, . . . ) | Available Capacity Periodic | | |
| | | | | or ABS Status Periodic. | | |
| Partial Success | O | | ENUMERATED | Included if partial success is | YES | ignore |
| Indicator | | | (partial | allowed | | |
| | | | success | | | |
| | | | allowed, . . . ) | | | |

NR Resource Status Response

The below table illustrates an example NR RESOURCE STATUS RESPONSE message. In some scenarios, the exemplified eNB1 may be the first network node 111, and the exemplified eNB2 may be the second network node 112.

Direction: eNB2→eNB1.

| | | | IE type and | | | Assigned |
|---|---|---|---|---|---|---|
| IE/Group Name | Presence | Range | reference | Semantics description | Criticality | Criticality |
| Message Type | M | | | | YES | reject |
| eNB1 Measurement ID | M | | INTEGER | Allocated by eNB₁ | YES | reject |
| | | | (1 . . . 4095, . . . ) | | | |
| eNB2 Measurement ID | M | | INTEGER | Allocated by eNB₂ | YES | reject |
| | | | (1 . . . 4095, . . . ) | | | |
| Criticality Diagnostics | O | | 9.2.7 | | YES | ignore |
| Measurement | | 0 . . . 1 | | List of all cells in which | YES | ignore |
| Initiation Result | | | | measurement objects were | | |
| | | | | requested, included when | | |
| | | | | indicating partial success | | |
| >Measurement | | 1 . . . | | | EACH | ignore |
| Initiation Result Item | | <max | | | | |
| | | neighbour | | | | |
| | | NR | | | | |
| | | cells in | | | | |
| | | eNB> | | | | |
| >>Cell ID | M | | NR CGI | | — | |
| | | | (NR Cell | | | |
| | | | Global | | | |
| | | | Identifier) | | | |
| >>Measurement | | 0 . . . 1 | | Indicates that eNB₂ could | — | |
| Failure Cause List | | | | not initiate the | | |
| | | | | measurement for at least | | |
| | | | | one of the requested | | |
| | | | | measurement objects in the | | |
| | | | | cell | | |
| >>>Measurement | | 1 . . . | | | EACH | ignore |
| Failure Cause | | <max | | | | |
| Item | | Failed | | | | |
| | | Meas | | | | |
| | | Objects> | | | | |
| >>>>Measurement | M | | BITSTRING | Each position in the bitmap | — | |
| Failed Report | | | (SIZE(32)) | indicates measurement | | |
| Characteristics | | | | object that failed to be | | |
| | | | | initiated in the eNB₂. First | | |
| | | | | Bit = PRB Periodic, | | |
| | | | | Second Bit = TNL load Ind | | |
| | | | | Periodic, | | |
| | | | | Third Bit = HW Load Ind | | |
| | | | | Periodic, | | |
| | | | | Fourth Bit = Composite | | |
| | | | | Available Capacity Periodic, | | |
| | | | | Fifth Bit = ABS Status | | |
| | | | | Periodic, | | |
| >>>>Cause | M | | 9.2.6 | Failure cause for | — | |
| | | | | measurement objects for | | |
| | | | | which the measurement | | |
| | | | | cannot be initiated | | |

NR Resource Status Update

The below table illustrates an example NR RESOURCE STATUS UPDATE message. In some scenarios, the exemplified eNB1 may be the first network node 111, and the exemplified eNB2 may be the second network node 112.

Direction: eNB2→eNB1.

| | | | IE type | | | |
|---|---|---|---|---|---|---|
| | | | and | Semantics | | Assigned |
| IE/Group Name | Presence | Range | reference | description | Criticality | Criticality |
| Message Type | M | | | | YES | ignore |
| eNB1 Measurement ID | M | | INTEGER | Allocated by | YES | reject |
| | | | (1 . . . 4095, . . . ) | eNB₁ | | |
| eNB2 Measurement ID | M | | INTEGER | Allocated by | YES | reject |
| | | | (1 . . . 4095, . . . ) | eNB₂ | | |
| Cell Measurement Result | | 1 | | | YES | ignore |
| >Cell Measurement Result | | 1 . . . <max | | | EACH | ignore |
| Item | | neighbour | | | | |
| | | NR cells in | | | | |
| | | eNB> | | | | |
| >>Cell ID | M | | NR CGI | | | |
| | | | (NR Cell | | | |
| | | | Global | | | |
| | | | Identifier) | | | |
| >>Hardware Load Indicator | O | | | | | |
| >>S1 TNL Load Indicator | O | | | | | |
| >>Radio Resource Status | O | | | | | |
| >>Composite Available | O | | | | YES | ignore |
| Capacity Group | | | | | | |
| >>ABS Status | O | | | | YES | ignore |
| >>Cell Reporting Indicator | O | | ENUMERATED | | YES | ignore |
| | | | (stop | | | |
| | | | request, . . . ) | | | |

gNB Communication

The above embodiments will now be further explained and exemplified in embodiments relating to methods herein performed by gNBs.

The above embodiments may be applied to following example scenarios when a gNB may need to perform LTE load-aware mobility decisions such as:
Selecting an LTE cell, e.g. cell 112c or cell 113c, that is less loaded for NE-DC service. E.g. to setup an LTE leg for NE-DC, one or more LTE cells, e.g. cell 112c or 113c, may need to be configured to allow non-NE-DC NR network nodes, e.g. the first network node 111, to move a wireless device, e.g. the wireless device 120, to an NE-DC capable NR cell, e.g. 112c or 113c that are less loaded to ensure better service for the wireless device. This may in some scenarios also reduce any potential LTE cell change from the NE-DC capable NR cell if the LTE cell, e.g. cell 112c or cell 113c, is highly loaded and cannot provide a required throughput.
In a connected mode from an NR cell, e.g. cell 111c, to an LTE cell, e.g. cell 112c or 113c, perform a handover, or perform a Release with Redirect to achieve better service for a wireless device, e.g. the wireless device 120. This may be performed e.g., due to lack of coverage on NR, or traffic load balancing purpose, or both.
Determining for LTE, a secondary cell group for a wireless device, e.g. the wireless device 120, cells which are not over-loaded.
For carrier aggregation using LTE leg, e.g. with any of cells 112c or 113c.

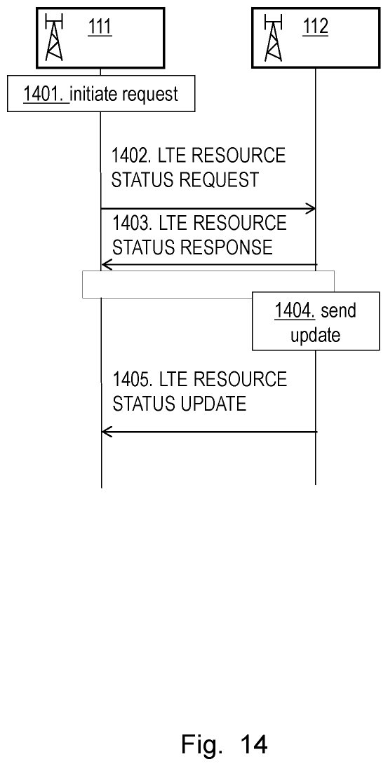

Similar to eNBs in LTE, gNBs in NR may also exchange inter-system, e.g. LTE, traffic load information between gNBs, using similar messages as exemplified above for eNBs. The messages below are examples and may be renamed with same functionality in any suitable manner. This procedure is further illustrated in FIG. 14, illustrating the first network node 111 exchanging messages with the second network node 112. In the example scenario of FIG. 14, the first network node 111 is a gNB, and the second network node 112 is a gNB. The procedure may involve the first network node 111 initiating 1401 a request. The first network node 111 may then transmit 1402 to the second network node 112, an LTE resource status request. The second network node 112 may respond and transmit 1403 to the first network node 111, an LTE resource status response message. Further, the second network node 112, may then periodically send 1404 updates to the first network node 111, which may involve transmitting 1404 an LTE resource status update message. The periodic update may further be configured to trigger every set time interval such as e.g. every 100 ms, 1 s, 2 s, 10 s, 30 s, or 60 s, or when ever the load has changed a specified amount, e.g. 5% or 10 Mbit/s or 100 physical resource blocks/10 ms, up or down.

LTE Resource Status Request

The below table illustrates an example LTE RESOURCE STATUS REQUEST message. In some scenarios, the exemplified NG-RAN node1 may be the first network node 111, and the exemplified NG-RAN node2 may be the second network node 112.

Direction: NG-RAN node1→NG-RAN node2.

| | | | IE type and | | | Assigned |
|---|---|---|---|---|---|---|
| IE/Group Name | Presence | Range | reference | Semantics description | Criticality | Criticality |
| Message Type | M | | | | YES | reject |
| NG-RAN node1 | M | | INTEGER | Allocated by NG-RAN node₁ | YES | reject |
| Measurement ID | | | (1 . . . 4095, . . . ) | | | |
| NG-RAN node2 | C- | | INTEGER | Allocated by NG-RAN node₂ | YES | ignore |
| Measurement ID | ifRegistration | | (1 . . . 4095, . . . ) | | | |
| | Request | | | | | |
| | Stopor | | | | | |
| | PartialStop | | | | | |
| | orAdd | | | | | |
| Registration | M | | ENUMERATED | Type of request for which the | YES | reject |
| Request | | | (start, | resource status is required. | | |
| | | | stop, . . . , | | | |
| | | | partial | | | |
| | | | stop, add) | | | |
| Report | O | | BITSTRING | Each position in the bitmap | YES | reject |
| Characteristics | | | (SIZE(32)) | indicates measurement object the | | |
| | | | | NG-RAN node₂ is requested to | | |
| | | | | report. | | |
| | | | | First Bit = PRB Periodic, | | |
| | | | | Second Bit = TNL load Ind | | |
| | | | | Periodic, | | |
| | | | | Third Bit = HW Load Ind Periodic, | | |
| | | | | Fourth Bit = Composite Available | | |
| | | | | Capacity Periodic, this bit should | | |
| | | | | be set to 1 if at least one of the | | |
| | | | | First, Second or Third bits is set | | |
| | | | | to 1, | | |
| | | | | Fifth Bit = ABS Status Periodic, | | |
| Cell To Report | | 1 | | Cell ID list to which the request | YES | ignore |
| List | | | | applies. | | |
| >Cell To | | 1 . . . | | | EACH | ignore |
| Report Item | | <max | | | | [symbol] |
| | | neighbour | | | | |
| | | LTE | | | | |
| | | cells in | | | | |
| | | NG- | | | | |
| | | RAN | | | | |
| | | node> | | | | |
| >>Cell ID | M | | ECGI | | — | |
| Reporting | O | | ENUMERATED | Periodicity that can be used for | YES | ignore |
| Periodicity | | | (1000 ms, | reporting of PRB Periodic, TNL | | |
| | | | 2000 ms, | Load Ind Periodic, HW Load Ind | | |
| | | | 5000 ms, | Periodic, Composite Available | | |
| | | | 10000 ms, . . . ) | Capacity Periodic or ABS Status | | |
| | | | | Periodic. | | |
| Partial Success | O | | ENUMERATED | Included if partial success is | YES | ignore |
| Indicator | | | (partial | allowed | | |
| | | | success | | | |
| | | | allowed, . . . ) | | | |

LTE Resource Status Response

The below table illustrates an example LTE RESOURCE STATUS RESPONSE message. In some scenarios, the exemplified NG-RAN node1 may be the first network node 111, and the exemplified NG-RAN node2 may be the second network node 112.

Direction: NG-RAN node2→NG-RAN node1.

| | | | IE type and | | | Assigned |
|---|---|---|---|---|---|---|
| IE/Group Name | Presence | Range | reference | Semantics description | Criticality | Criticality |
| Message Type | M | | | | YES | reject |
| NG-RAN node1 | M | | INTEGER | Allocated by NG-RAN node₁ | YES | reject |
| Measurement ID | | | (1 . . . 4095, . . . ) | | | |
| NG-RAN node2 | M | | INTEGER | Allocated by NG-RAN node₂ | YES | reject |
| Measurement ID | | | (1 . . . 4095, . . . ) | | | |
| Criticality Diagnostics | O | | | | YES | ignore |
| Measurement Initiation | | 0 . . . 1 | | List of all cells in which | YES | ignore |
| Result | | | | measurement objects were | | |
| | | | | requested, included when | | |
| | | | | indicating partial success | | |
| >Measurement | | 1 . . . | | | EACH | ignore |
| Initiation Result Item | | <max | | | | |
| | | neighbour | | | | |
| | | LTE | | | | |
| | | cells in | | | | |
| | | NG- | | | | |
| | | RAN | | | | |
| | | node> | | | | |
| >>Cell ID | M | | ECGI | | — | |
| >>Measurement | | 0 . . . 1 | | Indicates that NG-RAN | — | |
| Failure Cause List | | | | node₂ could not initiate the | | |
| | | | | measurement for at least | | |
| | | | | one of the requested | | |
| | | | | measurement objects in the | | |
| | | | | cell | | |

| | | | | | | |
|---|---|---|---|---|---|---|
| >>>Measurement | | 1 . . . | | | EACH | ignore |
| Failure Cause Item | | <max | | | | |
| | | Failed | | | | |
| | | Meas | | | | |
| | | Objects> | | | | |
| >>>>Measurement | M | | BITSTRING | Each position in the bitmap | — | |
| Failed Report | | | (SIZE(32) | indicates measurement | | |
| Characteristics | | | | object that failed to be | | |
| | | | | initiated in the NG-RAN | | |
| | | | | node₂. First Bit = PRB | | |
| | | | | Periodic, | | |
| | | | | Second Bit = TNL load Ind | | |
| | | | | Periodic, | | |
| | | | | Third Bit = HW Load Ind | | |
| | | | | Periodic, | | |
| | | | | Fourth Bit = Composite | | |
| | | | | Available Capacity Periodic, | | |
| | | | | Fifth Bit = ABS Status | | |
| | | | | Periodic, | | |
| >>>>Cause | M | | | Failure cause for | — | |
| | | | | measurement objects for | | |
| | | | | which the measurement | | |
| | | | | cannot be initiated | | |

LTE Resource Status Update

The below table illustrates an example LTE RESOURCE STATUS UPDATE message. In some scenarios, the exemplified NG-RAN node1 may be the first network node 111, and the exemplified NG-RAN node2 may be the second network node 112.

Direction: NG-RAN node2→NG-RAN node1.

| | | | IE type and | Semantics | | Assigned |
|---|---|---|---|---|---|---|
| IE/Group Name | Presence | Range | reference | description | Criticality | Criticality |
| Message Type | M | | | | YES | ignore |
| NG-RAN node1 | M | | INTEGER | Allocated by | YES | reje [symbol] |
| Measurement ID | | | (1 . . . 4095, . . . ) | NG-RAN | | |
| | | | | node₁ | | |
| NG-RAN node2 | M | | INTEGER | Allocated by | YES | reject |
| Measurement ID | | | (1 . . . 4095, . . . ) | NG-RAN | | |
| | | | | node₂ | | |
| Cell Measurement | | 1 | | | YES | ignore |
| Result | | | | | | |
| >Cell Measurement | | 1 . . . < max | | | EACH | ignore |
| Result Item | | neighbour LTE | | | | |
| | | cells in NG-RAN | | | | |
| | | node> | | | | |
| >>Cell ID | M | | ECGI | | | |
| >>Hardware Load | O | | | | | |
| Indicator | | | | | | |
| >>S1 TNL Load | O | | | | | |
| Indicator | | | | | | |
| >>Radio Resource | O | | | | | |
| Status | | | | | | |
| >>Composite | O | | | | YES | ignore |
| Available Capacity | | | | | | |
| Group | | | | | | |
| >>ABS Status | O | | | | YES | ignore |
| >>RSRP | O | | | | YES | ignore |
| Measurement | | | | | | |
| Report List | | | | | | |
| >>CSI Report | O | | | | YES | ignore |
| >>Cell Reporting | O | | ENUMERATED | | YES | ignore |
| Indicator | | | (stop request, . . . ) | | | |

Enhanced Radio Resource Status

The Radio Resource Status IE, e.g. as shown in above tables, may be defined for LTE to indicate the usage of PRBs for all traffic in Downlink and Uplink and the usage of Physical Downlink Control Channel (POOCH) consecutive control channel elements (CCEs) for Downlink and Uplink scheduling.

In addition to information in messages above, other load information relating to traffic load information, may further be communicated such as, e.g. a number of active UEs, number of RRC connected UEs. The definition of an active UE may in some scenarios be that a UE, e.g. the wireless device 120, has data in a buffer, the buffer may be in the RAN node, in the wireless device or in another node.

Any one or more of the Radio resource status, a number of active UEs, and number of RRC connected UEs, may then be included e.g. as an IE, when exchanging load information using the RESOURCE STATUS UPDATE message as e.g. shown for both LTE and NR above. This information may provide further details on how to achieve traffic load steering between frequency layers, e.g. different cells. Hence, in some embodiments, the load information used for determining the cell load may comprise any one or more of the following IEs in the table below, such as any one or more out of: PRB usage, PDCCH CCE usage, active UEs, or RRC connected UEs.

| | | | | |
|---|---|---|---|---|
| | | | | Semantics |
| IE/Group Name | Presence | Range | IE type and reference | description |

| | | |
|---|---|---|
| DL GBR PRB usage | M | INTEGER (0 . . . 100) |
| UL GBR PRB usage | M | INTEGER (0 . . . 100) |
| DL non-GBR PRB usage | M | INTEGER (0 . . . 100) |
| UL non-GBR PRB usage | M | INTEGER (0 . . . 100) |
| DL Total PRB usage | M | INTEGER (0 . . . 100) |
| UL Total PRB usage | M | INTEGER (0 . . . 100) |
| DL scheduling PDCCH CCE usage | O | INTEGER (0 . . . 100) |
| UL scheduling PDCCH CCE usage | O | INTEGER (0 . . . 100) |
| Number of Active UEs | O | INTEGER (0 . . . 100) |
| Number of RRC connected UEs | O | INTEGER (0 . . . 100) |

Wi-Fi Traffic Load

Embodiments herein may further relate to exchanging traffic load information over network nodes wherein one or more cells, e.g. the cell 113c, is a Wi-Fi cell. Hence, this enables determining to offload a wireless device, e.g. the wireless device 120, to a Wi-Fi cell, e.g. the cell 113c, when it involves an improved service for the wireless device. This may e.g. be performed in scenarios when a Wi-Fi cell, e.g. the cell 113c, is co-located with an LTE or NR cell, e.g. cell 112c. In some embodiments herein, a WiFi AP, e.g. the third node 113, may report load information to the second network node 112, periodically, at changed load, or due to a request from the second network node 112. In scenarios when the Wi-Fi AP, e.g. the third network node 113, is co-located with the second network node 112, the WiFi AP may be included in the same hardware unit as the second network node 112 or in a separate hardware unit, where the coverage area of the WiFi cell, e.g. cell 113c, partly or totally overlaps with the second cell 112c.

Inter-System Traffic Load Information Between Intra-System Nodes

Traffic load information may be made available according to the embodiments herein between any intra-system network nodes such as in the above-mentioned examples or in any of the following examples. The examples below may use any suitable way to communicate, such as e.g. the exemplified messages in embodiments herein.

eNB-to-eNB Requesting LTE Neighbour Load

In an example scenario, the first network node 111 may be an eNB, the second network node 112 may also be an eNB, and the third cell candidate 113c may be an LTE cell.

gNB-to-gNB Requesting NR Neighbour Load

In an example scenario, the first network node 111 may be a gNB, the second network node 112 may also be an gNB, and the third cell candidate 113c may be an NR cell.

eNB-to-gNB Requesting NR Neighbour Load

In an example scenario, the first network node 111 may be an eNB, the second network node 112 may be an gNB, and the third cell candidate 113c may be an LTE cell.

Cell Capabilities

In some embodiments, the capabilities, e.g. DC capabilities, of cells 111c, 112c, 113c, may appear different for the wireless device 120 and the network nodes 111, 112, 113. In an example scenario, the first cell 111c may be EN-DC capable cell from a network node perspective, e.g. network node 111, 112, 113, but not from the wireless device 120 perspective. In other words, if cell 111c is an LTE cell, the wireless device 120 may not be allowed to use EN-DC, and may only choose to utilize the second candidate cell 112c or the third candidate cell 113c.

Load Information

In some embodiments herein, a request for load information may be included in, or performed as part of X2 and/or Xn messages for Resource Status Reporting. This may relate to, or be part of any of actions 1001 and 1103.

In some embodiments herein, load information may comprise any one or more out of: cell capacity, used cell capacity, free cell capacity, hardware load, Transport Network Layer (TNL) load, and composite available capacity.

Cloud Implementation

FIG. 15 illustrates embodiments herein decoupling the methods herein to be performed in a centralized computing environment, for distributed Radio Nodes (RN), e.g. a first RN 1501a and a second RN 1501b, for serving the wireless device 1520. In the centralized computing environment may have a first Radio Control Function (RCF) 1500a and a second RCF 1500b.

The methods herein, e.g. when using E-UTRAN or NG-RAN, may be located in the RCFs for each respective RN, e.g. the control function parts of network nodes such as eNB, gNB or ng-eNB. The RCF may be located physically in a distributed entity close to the RNs or in a data center in a central location or on suitable hardware somewhere in between.

Hence, in some scenarios, the wireless device 1520 may be the wireless device 120, the first RN 1501a together with the first RCF 1500a may represent the first network node 111. The first RCF 1500a may e.g. perform above actions 1001-1003. The second RN 1501b together with the second RCF 1500b may represent the second network node 112. The second RCF 1500b may e.g. perform above actions 1101-1105.

Network Node Implementations

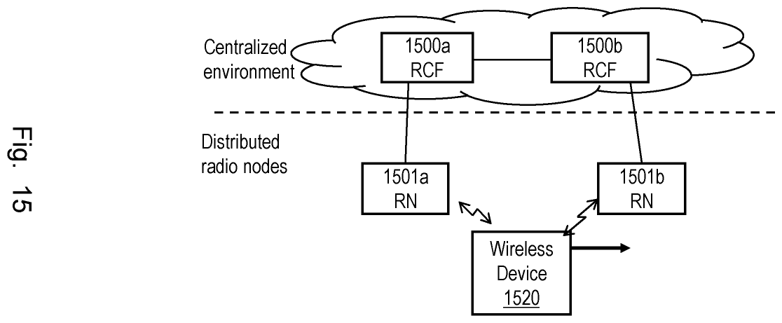

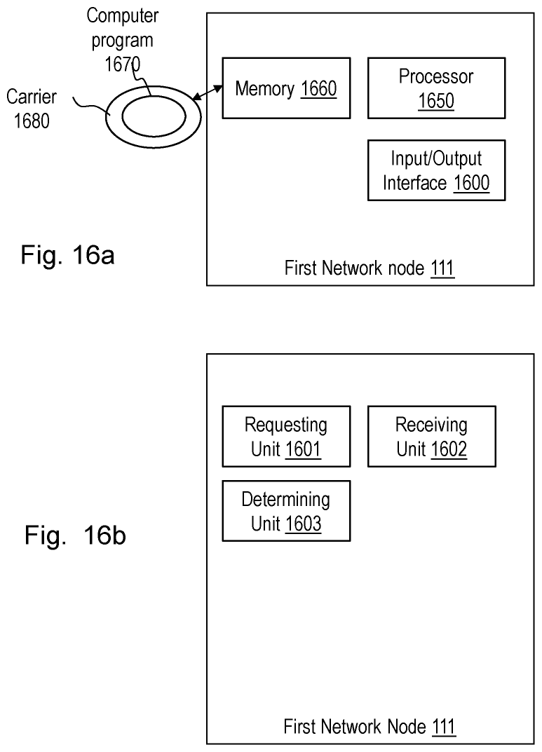

To perform the method actions above, the first network node 111 is configured to determine one or more cells to serve the wireless device 120 connected to the first network node 111 in the wireless communications network 100. The network node 111 may comprise an arrangement depicted in FIGS. 16a and 16b.

The first network node 111 may comprise an input and output interface 1600 configured to communicate with the wireless device 120 or network nodes such as e.g. the second network node 112. The input and output interface 1600 may comprise a wireless receiver (not shown) and a wireless transmitter (not shown).

The first network node 111 may further be configured to, e.g. by means of a requesting unit 1601, in the first network node, request from the second network node 112, a current load information for the third cell candidate 113c.

The first network node 111 may further be configured to, e.g. by means of the requesting unit 1601, in the first network node, request, from the second network node 112, a current load information for the second cell candidate 112c.

The first network node 111 may further be configured to, e.g. by means of a receiving unit 1602 in the first network node 111, in a control connection between the first network node 111 and the second network node 112, receive from the second network node 112, current load information for the third cell candidate 113c, wherein the third cell candidate 113c is arranged to be served by a third network node 113.

The first network node 111 may further be configured to, e.g. by means of the receiving unit 1602 in the first network node 111, receive from the second network node 112, current load information for a second cell candidate 112c wherein the second cell candidate 112c is adapted to be served by the second network node 112.

The first network node 111 may further be configured to, e.g. by means of a determining unit 1603, in the first network node 111, determine one or more cells to serve the wireless device 120 based on the current load information of the third cell candidate 113c.

The first network node 111 may further be configured to, e.g. by means of the determining unit 1603, in the first network node 111 determine the one or more cells to serve the wireless device 120 further based on the current load information for the second cell candidate 112c.

The first network node 111 may further be configured to, e.g. by means of the determining unit 1603 in the first network node 111, determine the one or more cells to serve the wireless device 120 as any one or more out of: a primary cell and a secondary cell, and wherein serving the wireless device 120 is arranged to be performed by use any one out of: CA, DC, and MPTCP.

The first network node 111 may further be configured to, e.g. by means of the determining unit 1603 in the first network node 111, determine the third cell candidate 113c to serve as any of: a primary cell, or a secondary cell, when the current load information for the third cell candidate 113c indicates a low load.

The first network node 111 may further be configured to, e.g. by means of the determining unit 1603 in the first network node 111, determine the one or more cells to serve the wireless device 120 by any one out of: determining the one or more cells to serve the wireless device 120 after a handover of the wireless device 120 to the determined one or more cells, and determining the one or more cells to serve the wireless device 120 after a redirection of the wireless device 120 to one of the determined one or more cells.

In some embodiments, the communications network 100 is adapted to be represented by a wireless multi RAT communications network. The connection between the first network node 111 and the wireless device 120 may be arranged to be connected using a first RAT, and wherein any one or more out of: the third cell candidate (113c) may be adapted to use a third RAT different from the first RAT, and the second cell candidate (112c) may be adapted to use a second RAT different from the first RAT.

The embodiments herein may be implemented through a respective processor or one or more processors, such as the processor 1650 of a processing circuitry in the first network node 111 depicted in FIG. 16a, together with respective computer program code for performing the functions and actions of the embodiments herein. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The first network node 111 may further comprise a memory 1660 comprising one or more memory units. The memory 1660 comprises instructions executable by the processor 1650 in the first network node 111. The memory 1660 is arranged to be used to store e.g. information, indications, data, configurations, and applications to perform the methods herein when being executed in the first network node 111.

In some embodiments, a computer program 1670 comprises instructions, which when executed by the respective at least one processor 1650, cause the at least one processor of the first network node 111 to perform the actions above.

In some embodiments, a respective carrier 1680 comprises the respective computer program 1670, wherein the carrier 1680 is one of an electronic signal, an optical signal, an electromagnetic signal, a magnetic signal, an electric signal, a radio signal, a microwave signal, or a computer-readable storage medium.

Those skilled in the art will appreciate that the units in the first network node 111 described above may refer to a combination of analog and digital circuits, and/or one or more processors configured with software and/or firmware, e.g. stored in the first network node 111, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

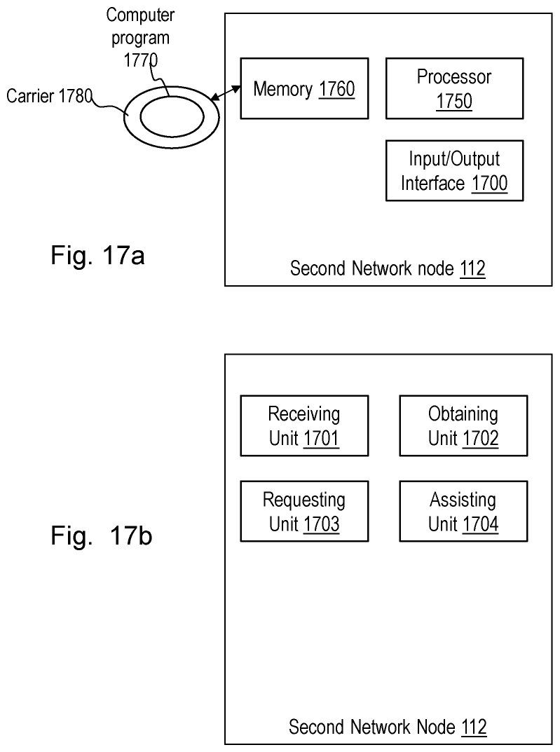

To perform the method actions above, the second network node 112 is configured to assist the first network node 111 in determining one or more cells to serve the wireless device 120 connected to the first network node 111 in the wireless communications network 100. The second network node 112 may comprise an arrangement depicted in FIGS. 17a and 17b.

The second network node 112 may comprise an input and output interface 1700 configured to communicate with the wireless device 120, or network nodes such as the first network node 111 or the third network node 113. The input and output interface 1700 may comprise a wireless receiver (not shown) and a wireless transmitter (not shown).

The second network node 112 may further be configured to, e.g. by means of a receiving unit 1701 in the second network node 112 in a control connection between the first network node 111 and the second network node 112, receive from the first network node 111, a request for current load information for a third cell candidate 113c.

The second network node 112 may further be configured to, e.g. by means of a receiving unit 1701 in the second network node 112, receive from the first network node 111, a request for current load information for the second cell candidate 112c served by the second network node 112.

The second network node 112 may further be configured to, e.g. by means of an obtaining unit 1702 in the second network node 112, obtain current load information for the second cell candidate 112c served by the second network node 112.

The second network node 112 may further be configured to, e.g. by means of the receiving unit 1701, and a requesting unit 1703, in the second network node 112, in a control connection between the second network node 112 and the third network node 113, request and receive from the third network node 113, current load information for the third cell candidate 113c served by the third network node 113.

The second network node 112 may further be configured to, e.g. by means of an assisting unit 1704, assist the first network node 111 in determining the one or more cells to serve the wireless device 120 by transmitting to the first network node 111, the current load information for the third cell candidate 113c adapted to be a basis for determining the one or more cells to serve the wireless device 120.

The second network node 112 may further be configured to, e.g. by means of the assisting unit 1704, assist the first network node 111 in determining the one or more cells to serve the wireless device 120 by transmitting to the first network node 111, the current load information for the second cell candidate 112c adapted to be a further basis for determining the one or more cells to serve the wireless device 120.

The second network node 112 may further be configured to, e.g. by means of the assisting unit 1704, assist the first network node 111 in determining the one or more cells to serve the wireless device 120 as any one or more out of: a primary cell and a secondary cell, and wherein to serve the wireless device 120 is arranged to be performed by using any one out of: Carrier Aggregation, CA, Dual Connectivity, DC, and Multi-Path Transport Control Protocol, MPTCP.

The second network node 112 may further be configured to, e.g. by means of the assisting unit 1704, assist the first network node 111 in determining the third cell candidate 113c to serve as any of: a primary cell, or a secondary cell, when the current load information for the third cell candidate 113c indicates a low load.

The second network node 112 may further be configured to, e.g. by means of the assisting unit 1704, assist the first network node 111 in determining the one or more cells to serve the wireless device 120 by any of: assisting the first network node in determining the one or more cells for handover of the wireless device 120, and assisting the first network node in determining the one or more cells for redirecting the wireless device 120 to the determined one or more cells.

In some embodiments, the communications network 100 is adapted to be represented by a wireless multi RAT communications network. The connection between the first network node 111 and the wireless device 120 may be arranged to be connected using a first RAT, and wherein any one or more out of: the second cell candidate 112c may be adapted to use a second RAT different RAT from the first RAT, and the third cell candidate 113c may be adapted to use a third RAT different from the first RAT.

The embodiments herein may be implemented through a respective processor or one or more processors, such as the processor 1750 of a processing circuitry in the second network node 112 depicted in FIG. 17a, together with respective computer program code for performing the functions and actions of the embodiments herein. The program code mentioned above may also be provided as a computer program product, for instance in the form of a data carrier carrying computer program code for performing the embodiments herein when being loaded into the second network node 112. One such carrier may be in the form of a CD ROM disc. It is however feasible with other data carriers such as a memory stick. The computer program code may furthermore be provided as pure program code on a server and downloaded to the second network node 112.

The second network node 112 may further comprise a memory 1760 comprising one or more memory units. The memory 1760 comprises instructions executable by the processor in the second network node 112. The memory 1760 is arranged to be used to store e.g. information, indications, data, configurations, and applications to perform the methods herein when being executed in the second network node 112.

In some embodiments, a computer program 1770 comprises instructions, which when executed by the respective at least one processor 1750, cause the at least one processor of the second network node 112 to perform the actions above.

In some embodiments, a respective carrier 1780 comprises the respective computer program 1770, wherein the carrier 1780 is one of an electronic signal, an optical signal, an electromagnetic signal, a magnetic signal, an electric signal, a radio signal, a microwave signal, or a computer-readable storage medium.

Those skilled in the art will appreciate that the units in the second network node 112 described above may refer to a combination of analog and digital circuits, and/or one or more processors configured with software and/or firmware, e.g. stored in the second network node 112, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

With reference to FIG. 18, in accordance with an embodiment, a communication system includes a telecommunication network 3210, such as a 3GPP-type cellular network, e.g. the wireless communications network 100, which comprises an access network 3211, such as a radio access network, and a core network 3214. The access network 3211 comprises a plurality of base stations 3212a, 3212b, 3212c, such as AP STAs NBs, eNBs, gNBs, e.g. the first network node 111, the second network node 112, or the third network node 113, or other types of wireless access points, each defining a corresponding coverage area 3213a, 3213b, 3213c, e.g. corresponding respectively to the first cell 111c, the second cell candidate 112c, and the third cell candidate 113c. Each base station 3212a, 3212b, 3212c is connectable to the core network 3214 over a wired or wireless connection 3215. A first UE such as a Non-AP STA 3291, e.g. the wireless device 120, located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, e.g. in the cloud 130, a distributed server or as processing resources in a server farm. The host computer 3230 may be under the ownership or control of a service provider or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 18 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

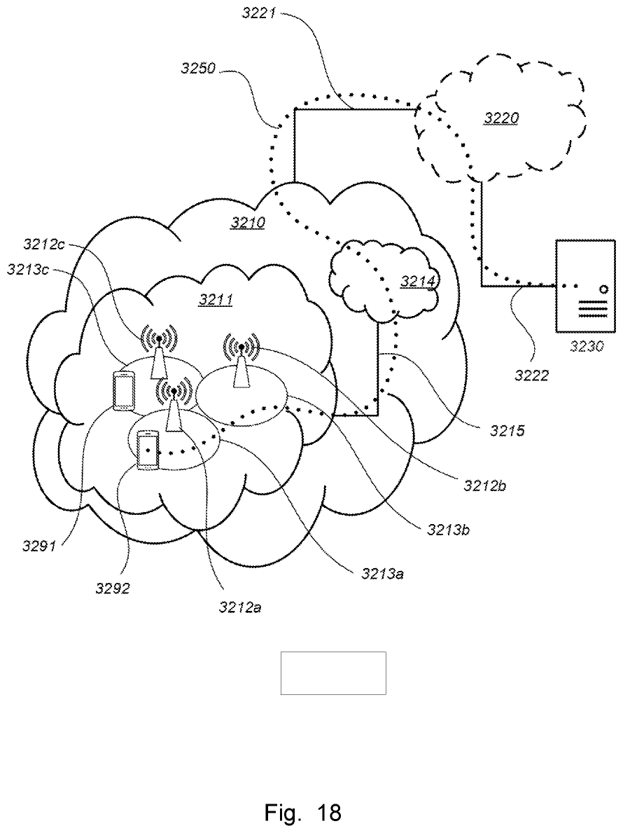

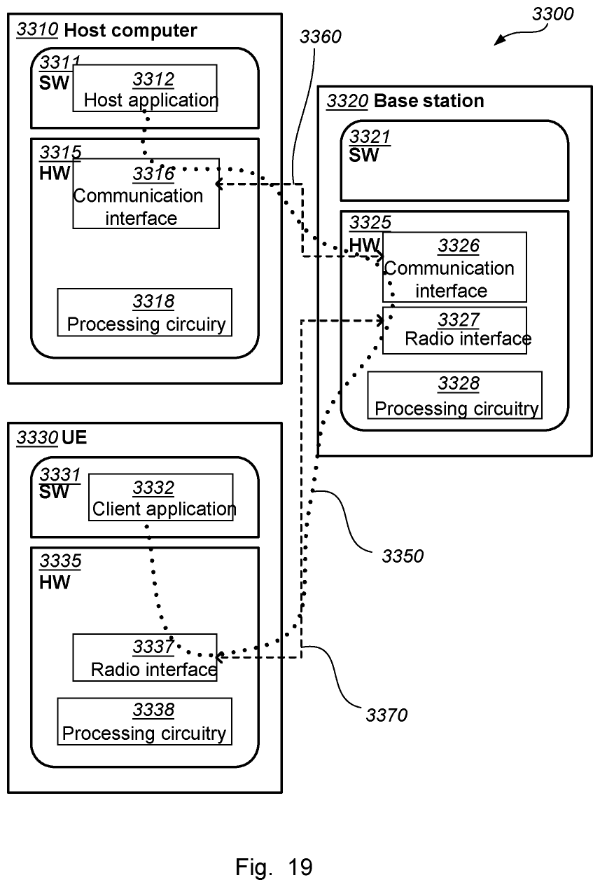

Example implementations, in accordance with an embodiment, of the UE, base station and host computer discussed in the preceding paragraphs will now be described with reference to FIG. 19. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 19) served by the base station 3320. The communication interface 3326 may be configured to facilitate a connection 3360 to the host computer 3310. The connection 3360 may be direct or it may pass through a core network (not shown in FIG. 19) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 18 may be identical to the host computer 3230, one of the base stations 3212a, 3212b, 3212c and one of the UEs 3291, 3292 of FIG. 19, respectively. This is to say, the inner workings of these entities may be as shown in FIG. 19 and independently, the surrounding network topology may be that of FIG. 18.

In FIG. 19, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

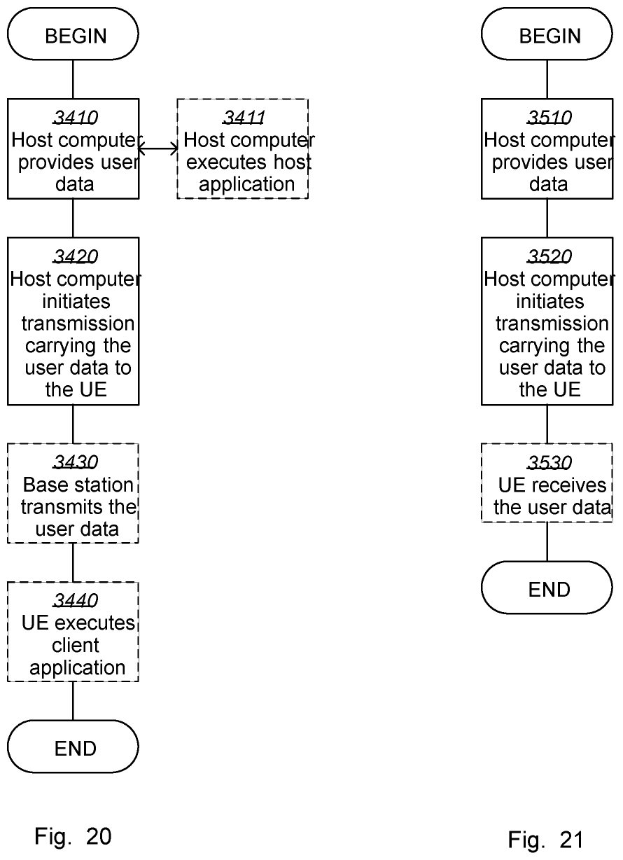

FIG. 20 is a flowchart illustrating a method implemented in a communication system, in accordance with one embodiment. The communication system includes a host computer, a base station such as an AP STA, and a UE such as a Non-AP STA which may be those described with reference to FIG. 18 and FIG. 19. For simplicity of the present disclosure, only drawing references to FIG. 20 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 21 is a flowchart illustrating a method implemented in a communication system, in accordance with one embodiment. The communication system includes a host computer, a base station such as an AP STA, and a UE such as a Non-AP STA which may be those described with reference to FIG. 18 and FIG. 19. For simplicity of the present disclosure, only drawing references to FIG. 21 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

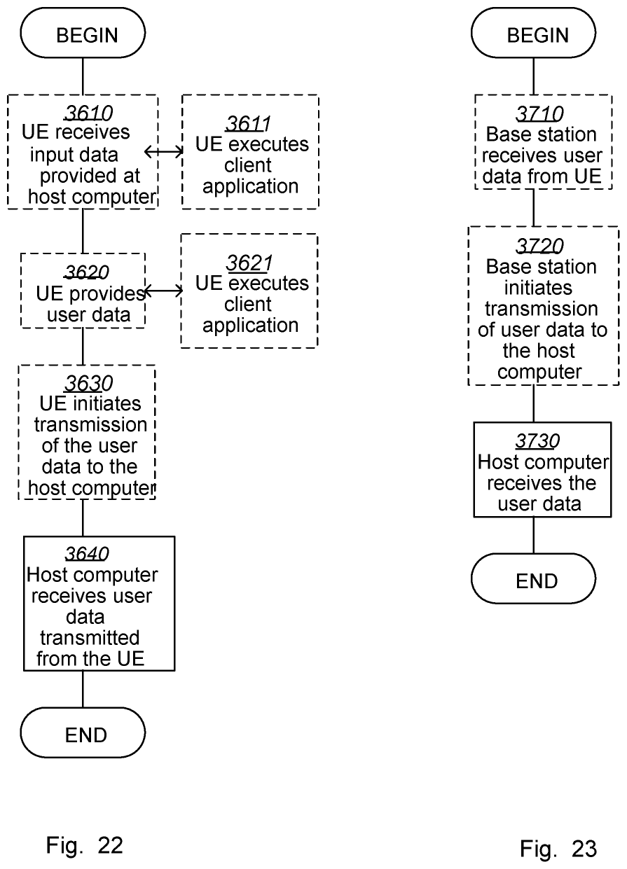

FIG. 22 is a flowchart illustrating a method implemented in a communication system, in accordance with one embodiment. The communication system includes a host computer, a base station such as an AP STA, and a UE such as a Non-AP STA which may be those described with reference to FIG. 18 and FIG. 19. For simplicity of the present disclosure, only drawing references to FIG. 22 will be included in this section. In an optional first step 3610 of the method, the UE receives input data provided by the host computer. Additionally, or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 23 is a flowchart illustrating a method implemented in a communication system, in accordance with one embodiment. The communication system includes a host computer, a base station such as an AP STA, and a UE such as a Non-AP STA which may be those described with reference to FIG. 18 and FIG. 19. For simplicity of the present disclosure, only drawing references to FIG. 23 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

Abbreviations

Below follows a list of abbreviations and their respective explanation.

| Abbreviation | Explanation |
|---|---|
| 3G | 3rd Generation Mobile System |
| 3GPP | 3rd Generation Partnership Program |
| 4G | 4th Generation Mobile System |
| 5G | 5th Generation Mobile System |
| 5GC | 5th Generation Core Network |
| 5GS | 5th Generation System |
| AMF | Access and Mobility Management Function |
| ARFCN | Absolute Radio Frequency Number |
| BW | Bandwidth |
| CGI | Cell Global Identity |
| CN | Core Network |
| EARFCN | E-UTRA Absolute Radio Frequency Number |
| ECGI | E-UTRA Cell Global Identity |
| eNB | Evolved Node B |
| EN-DC | EUTRAN-NR Dual Connectivity |
| en-gNB | E-UTRA-NR-gNB |
| EPC | Evolved Packet Core |
| EPS | Evolved Packet System |
| E-UTRA | Evolved Universal Terrestrial Radio Access |
| E-UTRAN | Evolved Universal Terrestrial Radio Access Network |
| gNB | 5th Generation Node B |
| HO | Handover |
| IE | Information Element |
| IFLB | Inter-Frequency Load Balancing |
| IMMCI | Idle Mode Mobility Carrier Info |
| LTE | Long Term Evolution |
| MME | Mobility Management Entity |
| NE-DC | NR-E-UTRA Dual Connectivity |
| ng-eNB | NG eNB |
| NG-RAN | 5th Generation Radio Access Network |
| NR | 5G New Radio |
| NR NSA | NR Non-Stand-Alone |
| NR SA | NR Stand-Alone |
| NSA | Non-Stand Alone |
| OTT | Over the top |
| Pcell | Primary Cell |
| RAN | Radio Access Network |
| RCF | Radio Control Function |
| RRC | Radio Resource Control |
| RN | Radio Node |
| SA | Standalone |
| SCS | Sub-carrier Spacing |
| S-GW | Serving Gateway |
| SIB | System Information Block |
| UE | User Equipment |
| X2 | Interface between eNBs |
| X2AP | X2 Application Protocol |
| Xn | Interface between gNBs and, gNB and eNB |
| XnAP | Xn Application Protocol |

1.-32. (canceled)

33. A method performed by a first network node for determining one or more cells to serve a wireless device connected to the first network node in a wireless communications network, the method comprising:
in a control connection between the first network node and a second network node, receiving, from the second network node, current load information for a third cell candidate, wherein the third cell candidate is served by a third network node; and
determining one or more cells to serve the wireless device based on the current load information of the third cell candidate.

34. The method according to claim 33, wherein said receiving further comprises receiving, from the second network node, current load information for a second cell candidate, wherein the second cell candidate is served by the second network node, and wherein determining the one or more cells to serve the wireless device is further based on the current load information for the second cell candidate.

35. The method according to claim 33, wherein the wireless communications network is represented by a wireless multi Radio Access Technology (RAT) communications network and wherein a connection between the first network node and the wireless device is connected using a first RAT, and wherein any one or more out of: the third cell candidate uses a third RAT different from the first RAT and the second cell candidate uses a second RAT different from the first RAT.

36. The method according to claim 33, further comprising requesting, from the second network node, any one or more out of: a current load information for the third cell candidate and a current load information for the second cell candidate.

37. The method according to claim 33, wherein determining the one or more cells to serve the wireless device comprises determining the one or more cells to serve the wireless device as any one or more out of: a primary cell and a secondary cell, and wherein serving the wireless device is performed by use of any one out of: Carrier Aggregation (CA), Dual Connectivity (DC), and a Multi-Path Transport Control Protocol (MPTCP).

38. The method according to claim 37, wherein determining the one or more cells to serve the wireless device comprises determining the third cell candidate to serve as any of: a primary cell or a secondary cell, when the current load information for the third cell candidate indicates a low load.

39. The method according to claim 33, wherein determining the one or more cells to serve the wireless device comprises any one out of:
determining the one or more cells to serve the wireless device after a handover of the wireless device to the determined one or more cells, and
determining the one or more cells to serve the wireless device after a redirection of the wireless device to one of the determined one or more cells.

40. A method performed in a second network node for assisting a first network node in determining one or more cells to serve a wireless device connected to the first network node in a wireless communications network, the method comprising:
in a control connection between the second network node and a third network node, receiving, from the third network node, current load information for a third cell candidate served by the third network node; and
assisting the first network node in determining the one or more cells to serve the wireless device by transmitting, to the first network node, the current load information for the third cell candidate as a basis for determining the one or more cells to serve the wireless device.

41. The method according to claim 40 further comprising: in a control connection between the first network node and the second network node, receiving, from the first network node, any one or more out of:
a request for current load information for the third cell candidate served by the third network node; and
a request for current load information for a second cell candidate served by the second network node.

42. The method according to claim 41, further comprising obtaining current load information for a second cell candidate served by the second network node, and wherein said assisting further comprises assisting the first network node in determining the one or more cells to serve the wireless device by transmitting, to the first network node, the current load information for the second cell candidate as a further basis for determining the one or more cells to serve the wireless device.

43. The method according to claim 40, wherein the wireless communications network is represented by a wireless multi Radio Access Technology (RAT) communications network and wherein a connection between the first network node and the wireless device is connected using a first RAT, and wherein any one or more out of: the second cell candidate uses a second RAT different RAT from the first RAT, and the third cell candidate uses a third RAT different from the first RAT.

44. The method according to claim 40, wherein assisting the first network node, comprises assisting the first network node in determining the one or more cells to serve the wireless device as any one or more out of: a primary cell and a secondary cell, and wherein serving the wireless device is performed by use any one out of: Carrier Aggregation (CA), Dual Connectivity (DC), and a Multi-Path Transport Control Protocol (MPTCP).

45. The method according to claim 44, wherein assisting the first network node, comprises assisting the first network node in determining the third cell candidate to serve as any of: a primary cell or a secondary cell, when the current load information for the third cell candidate indicates a low load.

46. The method according to claim 40, wherein assisting the first network node in determining the one or more cells to serve the wireless device comprises any one out of:
assisting the first network node in determining the one or more cells to serve the wireless device after a handover of the wireless device to the determined one or more cells; and
assisting the first network node in determining the one or more cells to serve the wireless device after a redirection of the wireless device to one of the determined one or more cells.

47. A first network node configured to determine one or more cells to serve a wireless device connected to the first network node in a wireless communications network, the first network node comprising processing circuitry configured to:
in a control connection between the first network node and a second network node, receive, from the second network node, current load information for a third cell candidate, wherein the third cell candidate is arranged to be served by a third network node; and
determine one or more cells to serve the wireless device based on the current load information of the third cell candidate.

48. The first network node according to claim 47, wherein the processing circuitry is further configured to:
receive, from the second network node, current load information for a second cell candidate, wherein the second cell candidate is adapted to be served by the second network node; and
determine the one or more cells to serve the wireless device further based on the current load information for the second cell candidate.

49. The first network node according to claim 47, wherein the wireless communications network is represented by a wireless multi Radio Access Technology (RAT) communications network and wherein a connection between the first network node and the wireless device is connected using a first RAT, and wherein any one or more out of: the third cell candidate uses a third RAT different from the first RAT and the second cell candidate uses a second RAT different from the first RAT.

50. The first network node according to claim 47, wherein the processing circuitry is further configured to request, from the second network node, any one or more out of: a current load information for the third cell candidate and a current load information for the second cell candidate.

51. The first network node according to claim 47, wherein the processing circuitry is configured to determine the one or more cells to serve the wireless device by determining the one or more cells to serve the wireless device as any one or more out of: a primary cell and a secondary cell, and wherein serving the wireless device is performed by use of any one out of: Carrier Aggregation (CA), Dual Connectivity (DC), and a Multi-Path Transport Control Protocol (MPTCP).

52. A second network node configured to assist a first network node in determining one or more cells to serve a wireless device connected to the first network node in a wireless communications network, the second network node comprising processing circuitry configured to:
in a control connection between the second network node and a third network node, receive, from the third network node, current load information for a third cell candidate served by the third network node, and
assist the first network node in determining the one or more cells to serve the wireless device by transmitting, to the first network node, the current load information for the third cell candidate as a basis for determining the one or more cells to serve the wireless device.
